(19) United States
(12) Patent Application Publication
(10) Pub. No.: US 2014/0059583 A1
(43) Pub. Date: Feb. 27, 2014

(54) TERMINAL MANAGEMENT SYSTEM

(71) Applicant: Panasonic Corporation, Osaka (JP)

(72) Inventors: Yosuke MATSUSHITA, Osaka (JP); Hideo MORITA, Osaka (JP); Hirokazu TAMANO, Osaka (JP)

(73) Assignee: Panasonic Corporation, Osaka (JP)

(21) Appl. No.: 14/068,850

(22) Filed: Oct. 31, 2013

Related U.S. Application Data
(63) Continuation of application No. PCT/JP2013/001317, filed on Mar. 4, 2013.

(30) Foreign Application Priority Data
Mar. 7, 2012 (JP) 2012-050709

(51) Int. Cl. H04N 21/254; H04N 21/835; H04N 21/4627

(52) U.S. Cl. CPC H04N 21/2541; H04N 21/4627; H04N 21/835
USPC 725/25

(57) ABSTRACT

A management server device (management server) 11 manages a terminal ID, a group ID, and application software so that the terminal ID, the group ID, and the application software are associated with each other and includes a change target selecting section 113 for selecting application software capable of being changed to a state that can be started in a TV device (movement destination terminal) 10a from application software that is currently capable of being started in a movement origin terminal belonging to the same group as that of the TV device (movement destination terminal) 10a, and sending information on the selected application software to the TV device (movement destination terminal) 10a. The TV device (movement destination terminal) 10a includes a terminal information sending section 101 and a change target display section 104 for displaying the information on the application software.

### TECHNICAL FIELD

The present invention relates to a terminal management system for managing a terminal capable of starting application software.

### BACKGROUND ART

As a method for managing a terminal capable of starting application software, there has been known a method using a license code. In this method, for example, a terminal can start application software only when the terminal stores a license code of the application software. Therefore, in the case where it is desired to move one license code of application software to allow another terminal to start the same application software, it is necessary to delete the license code stored in a terminal of a movement origin and to store the license code in a terminal of a movement destination.

For example, Patent Document 1 discloses a method for moving a license code by registering a license code created based on hardware-specific information on a computer of a movement origin, deleting the license code of the computer of the movement origin at a time of movement of a license, and newly creating a license code based on hardware-specific information on a computer of a movement destination.

### PRIOR ART DOCUMENT

### Patent Document

Patent Document 1: JP 2011-100476 A

### DISCLOSURE OF INVENTION

### Problem to be Solved by the Invention

However, in the method disclosed by Patent Document 1, a user needs to perform both an operation of deleting a license code in the computer of the movement origin and an operation of registering a license code in the computer of the movement destination. Therefore, in Patent Document 1, the user needs to operate both the computer of the movement origin and the computer of the movement destination at a time of movement of a license code, and hence, the method is cumbersome.

The present invention has been achieved in view of the above-mentioned problem, and it is an object of the present invention to provide a terminal management system capable of easily realizing license movement between a plurality of terminals of application software owned by a user.

### Means for Solving Problem

In order to achieve the above-mentioned object, a terminal management system disclosed below is a terminal management system including: a movement destination terminal to be a movement destination of a license of application software; and a management server capable of communicating with the movement destination terminal. The management server manages a terminal ID of each terminal including the movement destination terminal and a movement origin terminal to be a movement origin of the license, a group ID of a group to which each of the terminals belongs, and application software capable of being started in the each terminal so that the terminal ID, the group ID, and the application software are associated with each other. The management server includes a change target selecting section for selecting application software capable of being changed to a state that can be started in the movement destination terminal from application software that is currently capable of being started in the movement origin terminal belonging to the same group as that of the movement destination terminal based on the terminal ID and the group ID received from the movement destination terminal, and sending information on the selected application software to the movement destination terminal. The movement destination terminal includes: a terminal information sending section for sending the terminal ID and the group ID of the movement destination terminal to the management server; and a change target display section for displaying the information on the application software selected in the change target selecting section.

### Effects of the Invention

The disclosure of the present specification easily can realize license movement between a plurality of terminals of application software owned by a user.

### BRIEF DESCRIPTION OF DRAWINGS

FIG. 1 is a diagram showing an example of a system configuration of a terminal management system 1 according to the present invention.

FIG. 2A is a diagram showing an example of a functional block of the terminal management system 1 according to the present invention.

FIG. 2B is a diagram showing an example of a functional block of the terminal management system 1 according to the present invention.

FIG. 3 is a diagram showing an example of a hardware configuration of a TV device 10a shown in FIG. 2A realized through use of a CPU.

FIG. 4 is a diagram showing an example of data for connection.

FIG. 5 is a diagram showing an example of a hardware configuration of a management server device 11 shown in FIG. 2A realized through use of a CPU.

FIG. 6 is a diagram showing an example of a startup management table.

FIG. 7 is a diagram showing an example of a user management table.

FIG. 8 is a diagram showing an example of product data.

FIG. 9 is a diagram showing an example of a flowchart of main menu display processing.

FIG. 10 is a diagram showing an example of a “(0) Main menu screen”.

FIG. 11 is a view showing an example of an outer appearance of a remote controller 36 operated by a user who uses the TV device 10a.

FIG. 12 is a diagram showing an example of a “(1-1) Market menu screen”.

FIG. 13 is a diagram showing an example of a “(1-2) Application screen”.

FIG. 14 is a diagram showing an example of a “(1-1) Market menu screen”.

FIG. 15 is a diagram showing an example of a flowchart of possessed application list screen display processing.

FIG. 16 is a diagram showing an example of a “(2-9) Login screen”.

FIG. 17 is a diagram showing an example of a flowchart of own-terminal application software support processing.

FIG. 18 is a diagram showing an example of a flowchart of another-terminal application software support processing.

FIG. 19 is a diagram showing an example of a flowchart of independent application software support processing.

FIG. 20 is a diagram showing an example of a “(3-1) My account screen”.

FIG. 21 is a diagram showing an example of a flowchart of license movement processing.

FIG. 22 is a diagram showing an example of a “Confirmation screen”.

FIG. 23 is a diagram showing an example of a “(0) Main menu screen”.

FIG. 24 is diagram showing an example of screen transition of an entire system.

### DESCRIPTION OF THE INVENTION

Hereinafter, an embodiment of the present invention is described specifically with reference to the drawings.

### 1. First Embodiment

An example of a terminal management system according to the present embodiment is described below. The terminal management system according to the present embodiment is described by way of an example in which various services are provided to a user using a TV device through use of a management server device and a TV receiver (hereinafter referred to as “TV device”) as a terminal. The services include, for example, the sale of application software (which may be abbreviated below as “application” or “app”) and the sale of articles.

[1-1. System Configuration]

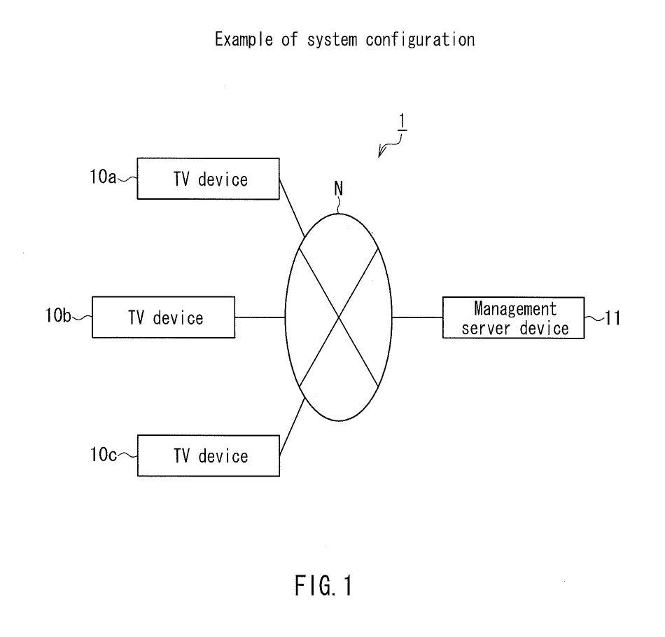

FIG. 1 is a diagram showing an example of a system configuration of a terminal management system 1. The terminal management system 1 includes a management server device 11 serving as a management server, a TV device 10a, a TV device 10b, a TV device 10c, and the like.

The management server device 11 is, for example, a computer device to be set on a side of a provider of the above-mentioned services. The TV device 10a and the TV device 10b are respectively TV devices that can be used by the same user. For example, both the TV device 10a and the TV device 10b are stationary TV devices to be set at a user's home or the like. The TV device 10c is a TV device that can be used by a user different from the user of the TV device 10a and the TV device 10b. Any or all of the TV device 10a, the TV device 10b, and the TV device 10c may be portable TV devices, smartphones, mobile phones, or the like.

The TV device 10a, the TV device 10b, or the TV device 10c, and the management server device 11 are capable of communicating with each other through a network N such as the Internet. The network N may be a network such as a WAN, a LAN, or an intranet. In FIG. 1, although only three TV devices: the TV device 10a, the TV device 10b, and the TV device 10c are shown, four or more TV devices may be present.

Note that, in the present embodiment, the terminal management system 1 is described with the TV device 10a being a movement destination terminal and the TV device 10b being a movement origin terminal.

Further, the TV device 10b that is a movement origin terminal is not necessarily required to be connected to the network N. This is because the TV device 10b cannot be connected to the network N when the TV device 10b is out of order.

The management server device 11 can provide, for example, a menu display image and the like to be used for providing service, to the TV device 10a, the TV device 10b, and the TV device 10c. Note that providing a menu display image and the like by the management server device 11 includes displaying a menu display image formed by the management server device 11 on the TV device and sending data required for forming a menu display image on the TV device side.

[1-2. Functional Block]

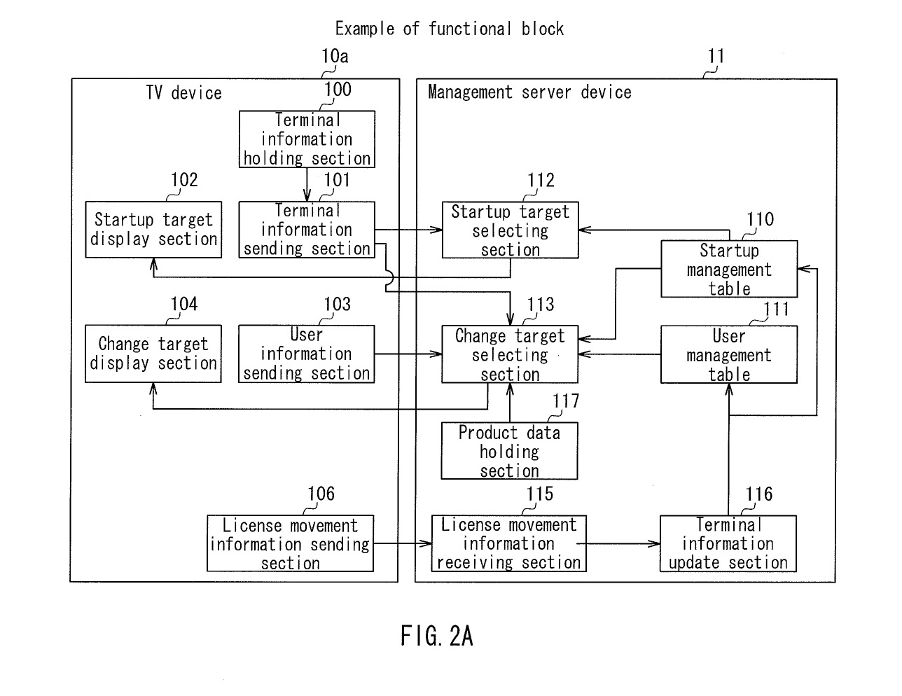

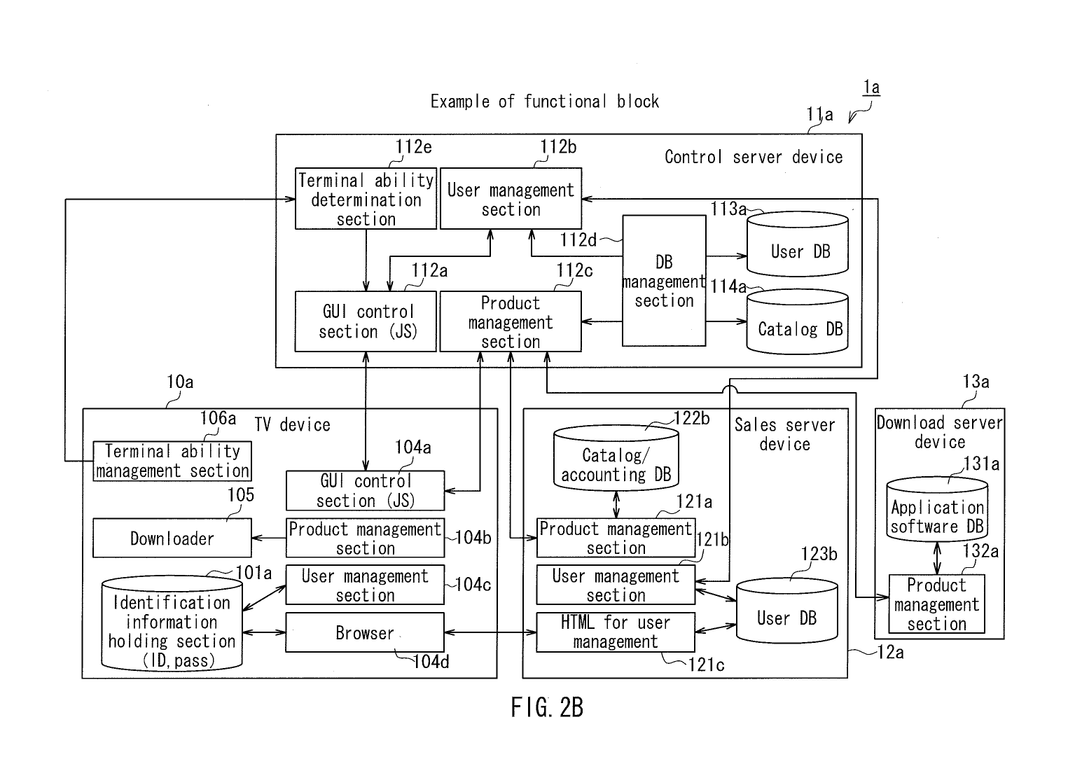

FIG. 2A shows an example of a functional block diagram of the terminal management system 1. As shown in FIG. 2A, the management server device 11 includes a startup management table 110, a user management table 111, a startup target selecting section 112, a change target selecting section 113, a license movement information receiving section 115, a terminal information update section 116, and a product data holding section 117.

Further, the TV device 10a includes a terminal information sending section 101, a startup target display section 102, a user information sending section 103, a change target display section 104, a license movement information sending section 106, and a terminal information holding section 100. Note that the TV device 10b and the TV device 10c shown in FIG. 1 can include functional sections similar to those of the TV device 10a.

[1-2-1. Management Server Device 11]

The startup management table 110 of the management server device 11 manages a terminal ID of each terminal including the TV device 10a serving as a movement destination terminal and the TV device 10b serving as a movement origin terminal, a group ID of a group to which each terminal belongs, and application software that can be started in each terminal so that the terminal ID, the group ID, and the application software are associated with each other.

The “terminal ID” refers to, for example, a code for identifying each terminal. The “group ID” refers to, for example, a code for identifying a group to which each terminal belongs. The “group to which each terminal belongs” refers to, for example, a group formed of terminals owned by the same user. The “user” also includes the case where a plurality of users (for example, a family) is collectively called “user”. Note that the present embodiment is described assuming that the TV device 10a and the TV device 10b belong to the same group.

The user management table 111 manages a user ID and password for identifying a user who uses the TV device (including the TV device 10a and the TV device 10b), information on application software purchased by the user in the past and currently owned by the user, and information on the TV device (including the TV device 10a and the TV device 10b) capable of starting the application software so that the user ID and password, the information on application software, and the information on the TV device are associated with each other. The term “own” means the ability to allow the application software to be available irrespective of whether it is on a chargeable basis or a non-chargeable basis.

Note that, besides the foregoing, the startup management table 110 and the user management table 111 may be configured as one table. Further, in the foregoing, although the case where the group ID and the user ID are provided separately is described, for example, the user ID may be used as the group ID.

The startup target selecting section 112 consults the startup management table 110 based on a terminal ID received from the TV device (for example, the TV device 10a) and selects application software that can be started in the TV device (for example, the TV device 10a). Thus, the startup target selecting section 112 can select application software depending on the TV device 10a serving as a movement destination terminal.

The change target selecting section 113 consults the startup management table 110 based on a terminal ID and a group ID received from the TV device (for example, the TV device 10a) serving as a movement destination terminal, and selects application software capable of being changed to a state that can be started in the TV device (for example, the TV device 10a) serving as a movement destination terminal from application software that is currently capable of being started in the TV device (for example, the TV device 10b) serving as a movement origin terminal belonging to the same group as that of the movement destination terminal and sends information on the selected application software to the TV device (for example, the TV device 10a) serving as a movement destination terminal. That is, the change target selecting section 113 selects application software whose license can be moved from the TV device (for example, the TV device 10b) serving as a movement origin terminal to the TV device (for example, the TV device 10a) serving as a movement destination terminal and sends information on the selected application software to the TV device (for example, the TV device 10a) serving as a movement destination terminal. Thus, the change target selecting section 113 can select application software depending on each terminal ID and group ID of the TV device 10a and the TV device 10b. Further, in the TV device (for example, the TV device 10a) serving as a movement destination terminal, the selected application software can be displayed, and thus the license of the application software easily can be moved.

Further, the change target selecting section 113 is configured so as to select application software capable of being changed to a state that can be started in the TV device (for example, the TV device 10a) serving as a movement destination terminal from independent application software not belonging to any of the terminals including the TV device (for example, the TV device 10a) serving as a movement destination terminal and the TV device (for example, the TV device 10b) serving as a movement origin terminal (described later in detail).

The license movement information receiving section 115 receives license movement information containing information on application software to be changed to a state that can be started in the TV device (for example, the TV device 10a) serving as a movement destination terminal, from the TV device (for example, the TV device 10a) serving as a movement destination terminal. Thus, the license movement information receiving section 115 can receive information on application software whose license is moved from the TV device 10b serving as a movement origin terminal to the TV device 10a serving as a movement destination terminal, from the TV device 10a.

The terminal information update section 116 updates information on a terminal capable of starting application software in the startup management table 110 and the user management table 111 based on the license movement information received from the TV device (for example, the TV device 10a) serving as a movement destination terminal. Thus, the terminal information update section 116 can update the information on the application software so that the license of the application software held in the startup management table 110 and the user management table 111 belongs to the TV device 10a serving as a movement destination terminal. Accordingly, the management server device 11 can exactly grasp the license movement of the application software.

Note that the following configuration also may be possible. The TV devices 10a and/or 10b inquire of the management server device 11 about the presence/absence of a license without fail at startup of the application software. If the TV devices 10a and/or 10b do not receive startup permission from the management server device 11, the TV devices 10a and/or 10b cannot start the application software.

In this case, for example, the management server device 11 receives a terminal ID and a request for starting application software from the TV device 10a and/or 10b, and can determine whether or not the TV device 10a and/or 10b of the terminal ID, which the management server device 11 has received, is capable of starting the application software, with reference to the startup management table 110. The management server device 11 sends determination results, that is, information indicating whether or not the application software can be started to the TV device 10a and/or the TV device 10b.

Thus, for example, even when a license is moved while the TV device 10b serving as a movement origin terminal is not connected to the network N, the TV device 10b serving as a movement origin terminal cannot start the application.

The product data holding section 117 holds product types, file names, and the like so that they are associated with product IDs.

Further, the change target selecting section 113 can select application software capable of being changed to a state that can be started in the TV device (for example, the TV device 10a) serving as a movement destination terminal, based on ability information received from the TV device (for example, the TV device 10a) serving as a movement destination terminal. Thus, the change target selecting section 113 determines whether or not terminal specifications of the TV device 10a satisfy requested specifications of application software, thereby selecting the application software. For example, the change target selecting section 113 determines whether or not the TV device 10a can display a 3D video if the application software displays a 3D video. Further, the change target selecting section 113 determines whether or not the TV device 10a has a browser function if the application software uses a browser. Further, the change target selecting section 113 determines whether or not the TV device 10a has a recording function if the application software requires a recording function.

[1-2-2. TV Device 10a]

The terminal information holding section 100 of the TV device 10a serving as a movement destination terminal includes a terminal ID and a group ID of the TV device 10a. For example, the terminal ID can be a Media Access Control (MAC) address uniquely assigned to the TV device 10a. Further, the terminal ID can be a hash value obtained by converting a MAC address by a predetermined hash function. Further, the terminal ID can be a unique ID assigned uniquely to the TV device 10a so as to identify the TV device 10a in the terminal management system 1. For example, the group ID can be a mail address of the user of the TV device 10a.

Note that the terminal information holding section 100 further may include ability information on the TV device 10a. For example, the ability information on the TV device 10a includes terminal specifications information on the TV device 10a. The “terminal specifications information” refers to information including image reproducing ability, application startup ability, image recording ability, and the like of the TV device. Specifically, the “terminal specifications information” refers to information indicating whether or not the TV device has a 3D video display function, a browser function, a recording function, or the like or information indicating the degrees of those functions.

The terminal information sending section 101 sends the terminal ID and the group ID of the TV device 10a serving as a movement destination terminal to the management server device 11. For example, the terminal information sending section 101 acquires the terminal ID and the group ID of the TV device 10a from the terminal information holding section 100 and sends them to the management server device 11.

The startup target display section 102 displays information on application software selected by the startup target selecting section 112 of the management server device 11, which can be started in the TV device 10a serving as a movement destination terminal, on the TV device 10a. For example, the startup target display section 102 displays an icon that is identification display information on application software associated with the terminal ID on the TV device 10a.

The user information sending section 103 sends a user ID and a password input by the user to the management server device 11, for example, in order to receive user authentication by the management server device 11.

The change target display section 104 receives information on the application software selected by the change target selecting section 113 of the management server device 11 and displays the information on the TV device 10a.

The license movement information sending section 106 sends license movement information generated when the user indicates information on the application software displayed on the change target display section 104 to the management server device 11.

[1-2-3. Another Configuration Example]

FIG. 2B shows an example of a functional block diagram in the case where the terminal management system of the present embodiment is carried out with a configuration according to an aspect different from that of the terminal management system 1 of FIG. 2A. The terminal management system 1a shown in FIG. 2B includes the TV device 10a, a control server device 11a, a sales server device 12a, and a download server device 13a.

The TV device 10a includes a GUI control section 104a, a product management section 104b, a user management section 104c, a browser 104d, an identification information holding section 101a, a downloader 105, and a terminal ability management section 106a.

The control server device 11a includes a GUI control section 112a, a user management section 112b, a product management section 112c, a DB management section 112d, a user database (DB) 113a, a catalog database (DB) 114a, and a terminal ability determination section 112e.

The sales server device 12a includes a catalog/accounting database (DB) 122b, a product management section 121a, a user management section 121b, an HTML for user management 121c, and a user database (DB) 123b.

The download server device 13a includes an application software database (DB) 131a and a product management section 132a.

The functions of the startup management table 110 in the management server device 11 shown in FIG. 2A include respective functions of the DB management section 112d, the user database (DB) 113a, and the catalog database (DB) 114a. The functions of the user management table 111 include respective functions of the DB management section 112d and the user database (DB) 113a. The functions of the startup target selecting section 112 include a function of the product management section 112c. The functions of the change target selecting section 113 include respective functions of the product management section 112c, the user management section 112b, and the terminal ability determination section 112e. The functions of the license movement information receiving section 115 include a function of the GUI control section 112a. The functions of the terminal information update section 116 include respective functions of the user management section 112b and the product management section 112c. The functions of the product data holding section 117 include each function of the catalog database (DB) 114a or the catalog/accounting database (DB) 122b.

The functions of the terminal information holding section 100 in the TV device 10a shown in FIG. 2A include a function of the identification information holding section 101a. The functions of the terminal information sending section 101 include respective functions of the user management section 104c and the GUI control section 104a. The functions of the startup display section 102 include a function of the GUI control section 104a. The functions of the user information sending section 103 include respective functions of the user management section 104c and the GUI control section 104a. The functions of the change target display section 104 include a function of the GUI control section 104a. The functions of the license movement information sending section 106 include a function of the GUI control section 104a.

[1-2-4. Others]

In the present embodiment, installing application software in the TV device 10a or the TV device 10b includes both installing download application software and installing hosted application software. For example, installing download application software includes setting a program downloaded from the management server device 11 so that the program can be run in the TV device 10a or the TV device 10b. For example, installing hosted application software includes setting data, which indicates the right (hereinafter, which may be referred to as “execution right”) to cause the management server device 11 to execute application software held in the management server device 11, in the TV device 10a or the TV device 10b.

Respective functional sections (startup target selecting section 112, change target selecting section 113, license movement information receiving section 115, terminal information update section 116) in the management server device 11 shown in FIG. 2A each include a function of a CPU to be realized by a program. Further, respective functional sections (terminal information sending section 101, startup target display section 102, user information sending section 103, change target display section 104, license movement information sending section 106) in the TV device 10a shown in FIG. 2A each include a function of a CPU to be realized by a program. Herein, the program includes not only a program that can be run directly by a CPU but also a source-format program, a compressed program, and an encoded program.

[1-3. Hardware Configuration]

[1-3-1. Configuration Example of TV Device 10a]

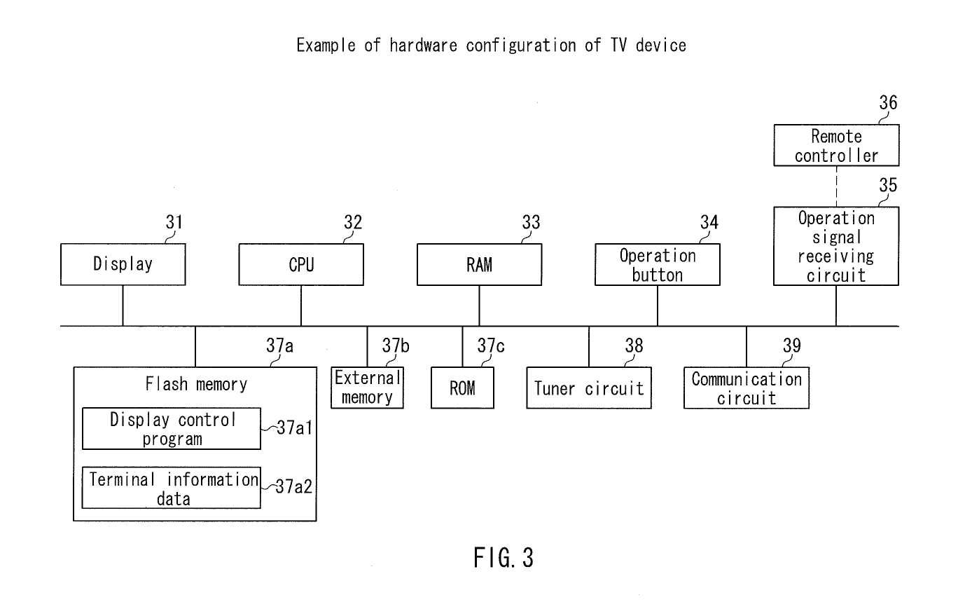

FIG. 3 is a diagram showing an example of a hardware configuration of the TV device 10a shown in FIG. 2A realized through use of a CPU. For example, the TV device 10a is a smart TV that can be connected to the network N. The TV device 10a includes a display 31, a CPU 32, a random access memory (RAM) 33, an operation button 34, an operation signal receiving circuit 35 capable of communicating with a remote controller 36, a flash memory 37a, an external memory 37b, a read only memory (ROM) 37c, a tuner circuit 38, and a communication circuit 39. Note that the TV device 10b and the TV device 10c can have a hardware configuration similar to that of the TV device 10a.

The display 31 can display a video signal output from a display control program 37a1. The video signal output from the display control program 37a1 contains a video signal for TV broadcasting output from the tuner circuit 38. The CPU 32 can execute processing based on an operating system (OS, not shown) and the display control program 37a1 through use of the RAM 33 and the like. The RAM 33 can provide an address space to the CPU 32 that runs the display control program 37a1.

The operation button 34 and the remote controller 36 can receive operation input from the user of the TV device 10a. The operation signal receiving circuit 35 can receive an operation signal output from the remote controller 36 that has received the operation input from the user. Note that the operation signal receiving circuit 35 may be configured so as to send a data signal to the remote controller 36.

The flash memory 37a can hold the display control program 37a1, a terminal information data 37a2, and the like. Note that the terminal information data 37a2 and the like held in the flash memory 37a may be present in an external device accessible through the communication circuit 39.

The external memory 37b can hold various data. For example, the external memory 37b can hold an application software program downloaded from the management server device 11. For example, an SD memory card (trade name) corresponds to the external memory 37b.

The ROM 37c can hold an OS, a MAC address, and the like. Note that a hard disk drive (HDD) may be provided in the TV device 10a, and the OS, the display control program 37a1, the terminal information data 37a2, and the like may be held in the hard disk.

The tuner circuit 38 can receive a TV broadcasting airwave in accordance with a setting country and a setting region through a receiving antenna (not shown). The communication circuit 39 can communicate with the management server device 11, for example, through the network N (FIG. 1) such as the Internet.

Respective functional sections (terminal information sending section 101, startup target display section 102, user information sending section 103, change target display section 104, license movement information sending section 106) in the TV device 10a shown in FIG. 2A are realized specifically, for example, by executing information processing of the display control program 37a1 on the CPU 32. The terminal information holding section 100 is realized specifically, for example, by one region of the flash memory 37a holding the terminal information data 37a2.

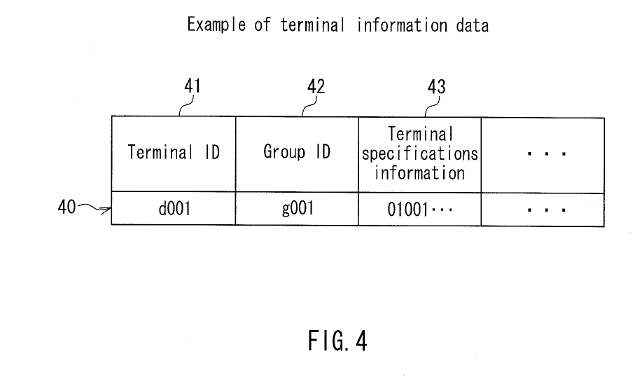

FIG. 4 is a diagram showing an example of the terminal information data 37a2. The terminal information data 37a2 contains a terminal ID 41, a group ID 42, terminal specifications information 43, and the like. The terminal ID 41 is data for identifying the TV device 10a between the TV device 10a and the management server device 11. For example, the terminal ID 41 can be a MAC address set at a time of shipment of the TV device 10a from a factory. The group ID 42 is data for identifying a group to which a terminal such as the TV device 10a belongs. For example, the group ID42 can be an E-mail address of the user of the TV device 10a.

The terminal specifications information 43 is information indicating terminal ability of the TV device 10a. For example, the terminal specifications information 43 can be bit string data that is expressed by assigning whether or not the TV device 10a has predetermined ability to each bit. Specifically, the terminal specifications information 43 is expressed by assigning the presence/absence of display ability of a 3D video, the presence/absence of a browser function, the presence/absence of a recording function, and the like to respective predetermined bits. Note that it is not necessarily required that the terminal specifications information 43 be contained in the terminal information data 37a2, and may be held independently from the terminal information data 37a2. Further, the terminal specifications information 43 can be sent to the management server device 11 at an arbitrary timing.

In FIG. 4, for example as shown in a record 40, a terminal ID 41 “d001”, a group ID 42 “g001”, and terminal specifications information 43 “01001 . . . ” are recorded.

[1-3-2. Configuration Example of Management Server Device 11]

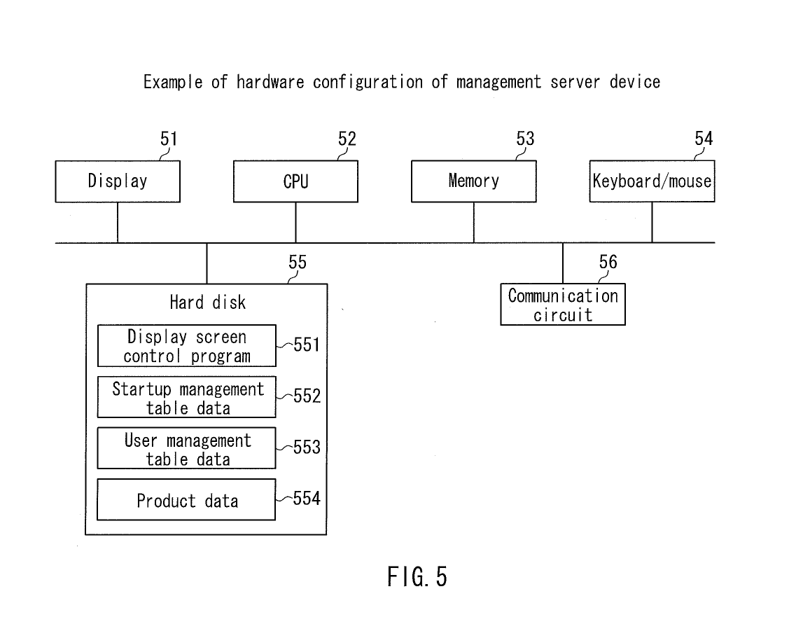

FIG. 5 is a diagram showing an example of a hardware configuration of the management server device 11 shown in FIG. 2 realized through use of a CPU. The management server device 11 is, for example, a server/computer device that can be connected to the network N. The management server device 11 includes a display 51, a CPU 52, a memory 53, a keyboard/mouse 54, a hard disk 55, and a communication circuit 56.

The display 51 can display various processing states of the management server device 11 on a screen. The CPU 52 can execute processing based on an operating system (OS, not shown) and a display screen control program 551 through use of a memory 53 and the like. The memory 53 can provide an address space to the CPU 52 that runs the display screen control program 551. The keyboard/mouse 54 can output an operation signal generated in response to the user's operation of the management server device 11 to the CPU 52. The hard disk 55 can hold the display screen control program 551, startup management table data 552, user management table data 553, product data 554, and the like in addition to the OS. The communication circuit 56 can communicate with the TV device 10a, the TV device 10b, or the TV device 10c through the network N (FIG. 1). Note that the display screen control program 551, the startup management table data 552, the user management table data 553, the product data 554, and the like held in the hard disk 55 may be present in an external device accessible through the communication circuit 56.

Respective functional sections (startup target selecting section 112, change target selecting section 113, license movement information receiving section 115, terminal information update section 116) in the management server device 11 shown in FIG. 2A are realized specifically, for example, by executing information processing of the display screen control program 551 on the CPU 52. Further, the startup management table 110 is realized specifically, for example, by one region of the hard disk 55 holding the startup management table data 552. Further, the user management table 111 is realized specifically, for example, by one region of the hard disk 55 holding the user management table data 553. Further, the product data holding section 117 is realized specifically, for example, by one region of the hard disk 55 holding the product data 554.

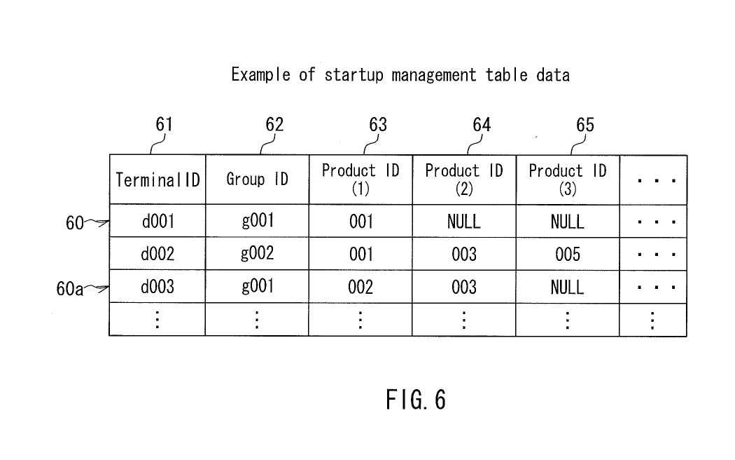

FIG. 6 is a diagram showing an example of the startup management table data 552. The startup management table data 552 contains a terminal ID 61, a group ID 62, a product ID (1) 63, a product ID (2) 64, a product ID (3) 65, . . . etc.

The terminal ID 61 is data for identifying the TV device 10a between the TV device 10a and the management server device 11 in the same way as in the terminal ID 41 (FIG. 4). The group ID 62 is data for identifying a group to which a terminal such as the TV device 10a belongs in the same way as in the group ID 42 (FIG. 4).

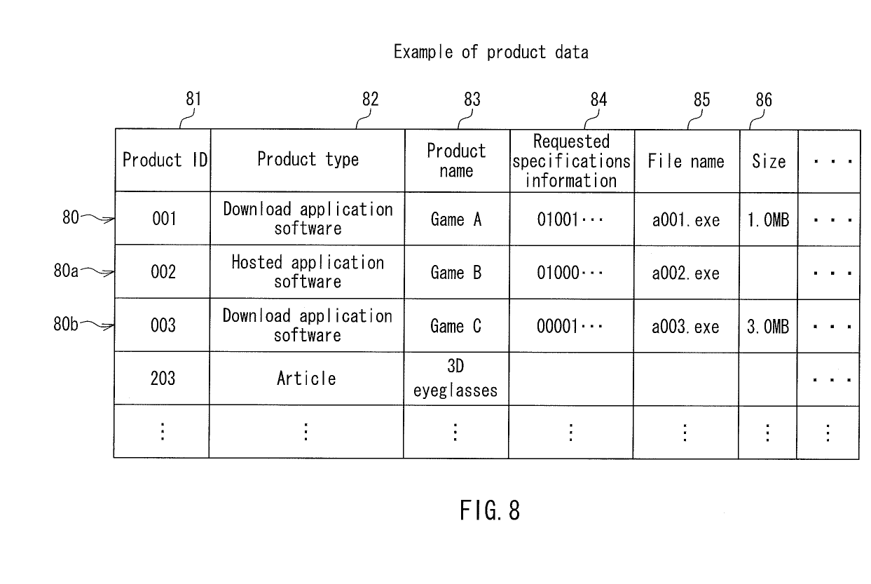

The product ID (1) 63, the product ID (2) 64, the product ID (3) 65, . . . are respectively data indicating application software that can be started in the TV device 10a corresponding to the terminal ID 61. For example, a code system of data held by the product ID (1) 63, the product ID (2) 64, the product ID (3) 65, and the like is common to a code system of data held by a product ID 81 of product data (FIG. 8) described later.

Therefore, application software can be specified by referring to the product data (FIG. 8) based on the data held by the product ID (1) 63, the product ID (2) 64, the product ID (3) 65, . . . . Note that, although only three product IDs: product ID (1) 63, product ID (2) 64, and product ID (3) 65 are described in FIG. 6, the startup management table data 552 can hold four or more product IDs.

In FIG. 6, for example as shown in a record 60, a terminal ID 61 “d001”, a group ID 62 “g001”, a product ID (1) 63 “001”, a product ID (2) 64 “NULL (no value)”, and a product ID (3) 65 “NULL” are recorded.

Note that the terminal ID 61 “d001” corresponds to the TV device 10a serving as a movement destination terminal, and a terminal ID 61 “d003” corresponds to the TV device 10b serving as a movement origin terminal. Further, the group ID “g001” corresponds to a group to which the TV device 10a and the TV device 10b belong. Further, the product ID (1) 63 “001” corresponds to the product ID 81 “001” indicating a product name 83 “Game A” in FIG. 8.

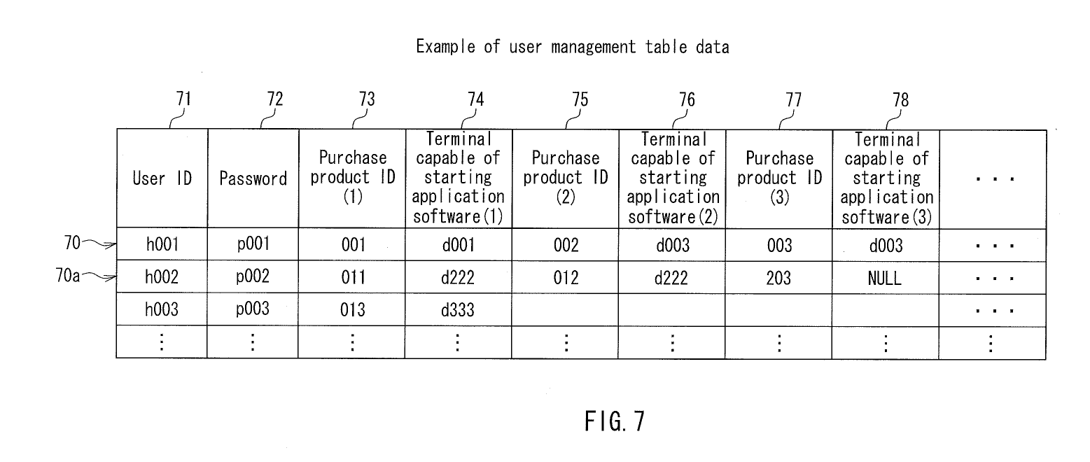

FIG. 7 is a diagram showing an example of the user management table data 553. The user management table data 553 contains a user ID 71, a password 72, a purchase product ID (1) 73, a terminal capable of starting application software (1) 74, a purchase product ID (2) 75, a terminal capable of starting application software (2) 76, a purchase product ID (3) 77, a terminal capable of starting application software (3) 78 . . . , etc.

The user ID 71 is data for identifying a user who uses the TV device 10a between the TV device 10a and the management server device 11. For example, the user ID 71 is set in the case where the user who uses the TV device 10a performs user registration processing (not shown).

The purchase product ID (1) 73, the purchase product ID (2) 75, and the purchase product ID (3) 77, . . . are data for specifying application software purchased by the user in the past. The terminal capable of starting application software (1) 74, the terminal capable of starting application software (2) 76, and the terminal capable of starting application software (3) 78, . . . are data for specifying terminals capable of respectively starting the purchase product ID (1) 73, the purchase product ID (2) 75, and the purchase product ID (3) 77, . . . . For example, a purchase product ID (1) 73 “001” can be started in the TV device 10a specified as a terminal capable of starting application software (1) 74 “d001”.

In FIG. 7, for example as shown in a record 70, a user ID 71 “h001”, a password 72 “p001”, the purchase product ID (1) 73 “001”, the terminal capable of starting application software (1) 74 “d001”, a purchase product ID (2) 75 “002”, a terminal capable of starting application software (2) 76 “d003”, a purchase product ID (3) 77 “003”, and a terminal capable of starting application software (3) 78 “d003” are recorded.

FIG. 8 is a diagram showing an example of the product data 554. The product data 554 contains the product ID 81, a product type 82, a product name 83, requested specifications information 84, a file name 85, a size 86, and the like. The product ID 81 is data for identifying each product. The product type 82 is data for discriminating among product types. For example, the product type 82 includes information such as “Hosted application software”, “Download application software”, “Article”, and the like. The product name 83 is a name assigned to a product.

In the case where a product identified by the product ID 81 is hosted application software or download application software, the requested specifications information 84 is information indicating terminal ability requested with respect to each terminal (for example, the TV device 10a, etc.) for starting these application software programs. For example, the requested specifications information 84 can be bit string data expressed by assigning predetermined ability to each bit through use of the same format as that of the terminal specifications information 43 shown in FIG. 4. Specifically, the requested specifications information 84 is expressed by assigning the presence/absence of display ability of a 3D video, the presence/absence of a browser function, the presence/absence of a recording function, and the like to respective predetermined bits in the same way as in the terminal specifications information 43.

In the case where a product identified by the product ID 81 is hosted application software or download application software, the file name 85 is a name of each substantial file of these application software programs. Note that the file name 85 may include information on an absolute position or a relative position of a place where a substantial file is held.

In FIG. 8, for example as shown in a record 80, a product ID 81 “001”, a product type 82 “Download application software”, the product name 83 “Game A”, requested specifications information 84 “01001 . . . ”, a file name 85 “a001.exe”, a size 86 “1.0 MB”, and the like are recorded.

[1-4. Example of Screen Processing]

The screen processing in the present embodiment refers to processing of causing the display 31 such as the TV device 10a to display a screen including various images other than a received video of TV broadcasting. The screen includes images such as an icon menu of executable application software (main menu), a mail-order service product menu (market menu), and various setting menus. For example, the CPU 32 of the TV device 10a accesses the management server device 11 in response to a user's operation and requests the “(0) Main menu screen”.

[1-4-1. Example of Main Menu Display Processing]

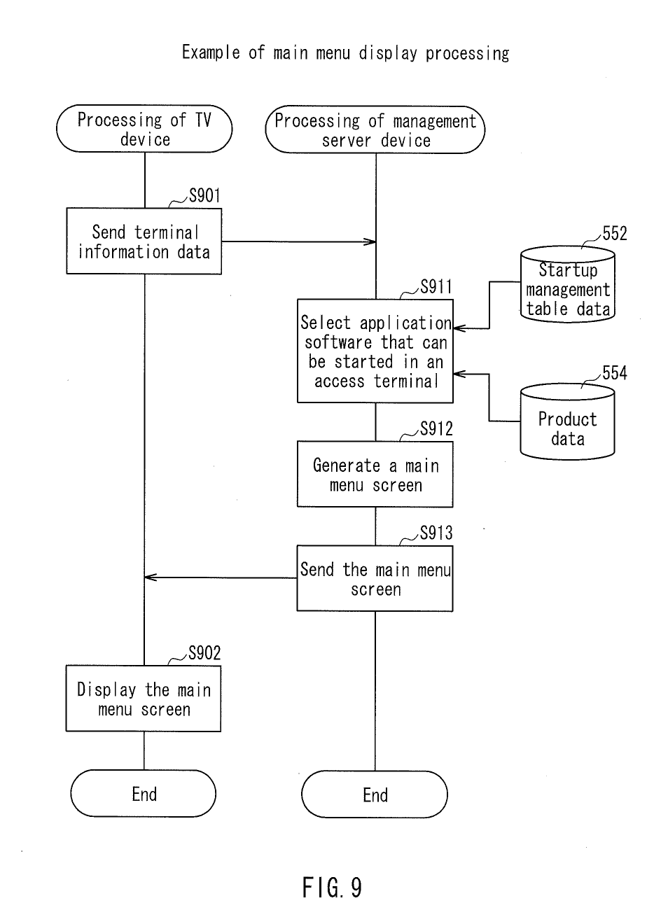

FIG. 9 is a diagram showing an example of a flowchart of main menu display processing. When the CPU 32 of the TV device 10a requests the “(0) Main menu screen” with respect to the management server device 11, the CPU 32 sends the terminal information data 37a2 held in the hard disk 37 of the TV device 10a to the management server device 11 (Step S901). For example, the CPU 32 sends the terminal ID 41 “d001”, the group ID 42 “g001”, and the terminal specifications information 43 “01001 . . . ” to the management server device 11 as the terminal information data, as shown in the record 40 of the terminal information data 37a2 (FIG. 4).

Note that the timing at which the CPU 32 of the TV device 10a sends the terminal information data 37a2 to the management server device 11 is arbitrary. For example, the CPU 32 of the TV device 10a can send the terminal information data 37a2 to the management server device 11 simultaneously with the request for the “(0) Main menu screen” or at any timing after the request.

When the CPU 52 of the management server device 11 receives the transmission of the terminal information data 37a2 from the TV device 10a, the CPU 52 selects application software that can be started in the TV device 10a serving as an access terminal (Step S911). For example, the CPU 52 refers to the startup management table data 552 (FIG. 6) based on the terminal ID41 “d001” included in the terminal information data 37a2 and extracts the product ID (1) 63 “001”, the product ID (2) 64 “NULL”, and the product ID (3) 65 “NULL” associated with the terminal ID 61 “d001” that is the same terminal ID as the terminal ID 41 “d001”.

Then, the CPU 52 selects application software corresponding to all the extracted product IDs as the application software that can be started in the TV device 10a, and acquires a product name (for example, the product name 83 “Game A”) corresponding to the selected application software with reference to the product data 554 (FIG. 8) based on the product ID of the selected application software.

The CPU 52 generates the “(0) Main menu screen” on which the selected application software can be started (Step S912). For example, the CPU 52 generates the “(0) Main menu screen” including a startup icon of the application software corresponding to the product ID (1) 63 “001”.

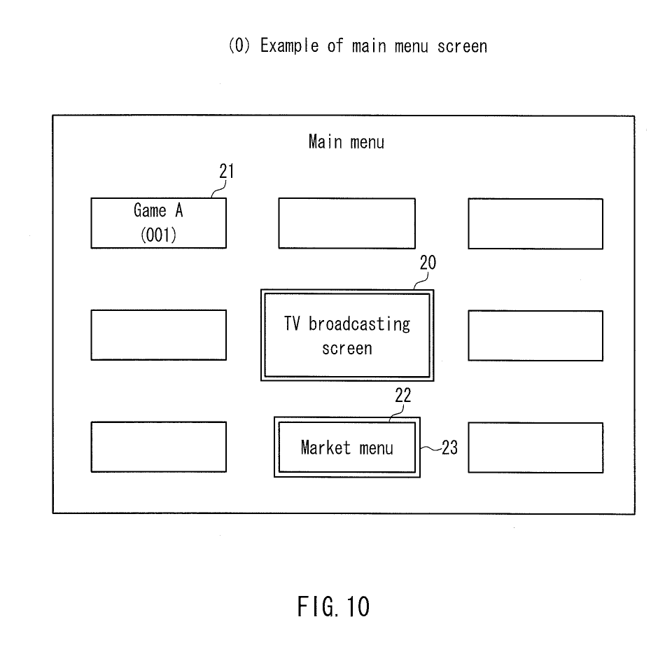

FIG. 10 is a diagram showing an example of the “(0) Main menu screen”. The “(0) Main menu screen” includes a TV broadcasting screen 20, a startup icon 21 of the “Game A (001)” that is application software corresponding to the product ID (1) 63 “001”, and a market menu icon 22.

The CPU 52 sends the generated “(0) Main menu screen” to the TV device 10a (Step S913). The CPU 32 of the TV device 10a receives the transmission from the management server device 11, and displays, for example, the “(0) Main menu screen” shown in FIG. 10 on a display (Step S902).

The TV broadcasting screen 20 is a screen on which videos based on video signals output from the tuner circuit 38 of the TV device 10a having received a TV broadcasting airwave are displayed successively. The startup icon 21 of the “Game A (001)” is an icon for starting the “Game A” that is application software capable of being started in the TV device 10a. The market menu icon 22 is an icon for shifting to a “(1-1) Market menu screen” in a lower layer of the “(0) Main menu screen”.

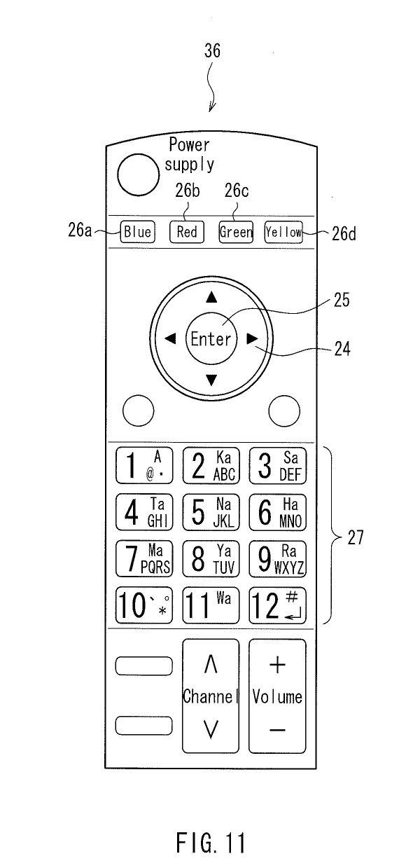

FIG. 11 is a view showing an example of an outer appearance of a remote controller 36 operated by a user who uses the TV device 10. The remote controller 36 includes at least a number and character input key 27, a direction key 24, an enter key 25, a blue color button 26a, a red color button 26b, a green color button 26c, and a yellow color button 26d (hereinafter, the blue color button 26a, the red color button 26b, the green color button 26c, and the yellow color button 26d simply may be referred to as “color button 26”).

[1-4-1-1. Example of Purchase Processing]

The startup icon 21 of the “Game A (001)” displayed on the “(0) Main menu screen” shown in FIG. 10 is an icon displayed when the user purchases application software. An example of the purchase processing is described below.

In the “(0) Main menu screen” shown in FIG. 10, for example, the user operates the direction key 24 of the remote controller 36 to set an icon selection frame 23 to the market menu icon 22. When the user presses the enter key 25 while the icon selection frame 23 is set to the market menu icon 22, the CPU 32 of the TV device 10a displays the “(1-1) Market menu screen”. In the following description of the present specification, the action in which the user presses the enter key 25 while the icon selection frame 23 is set to any icon or button may be simply referred to as “selection”.

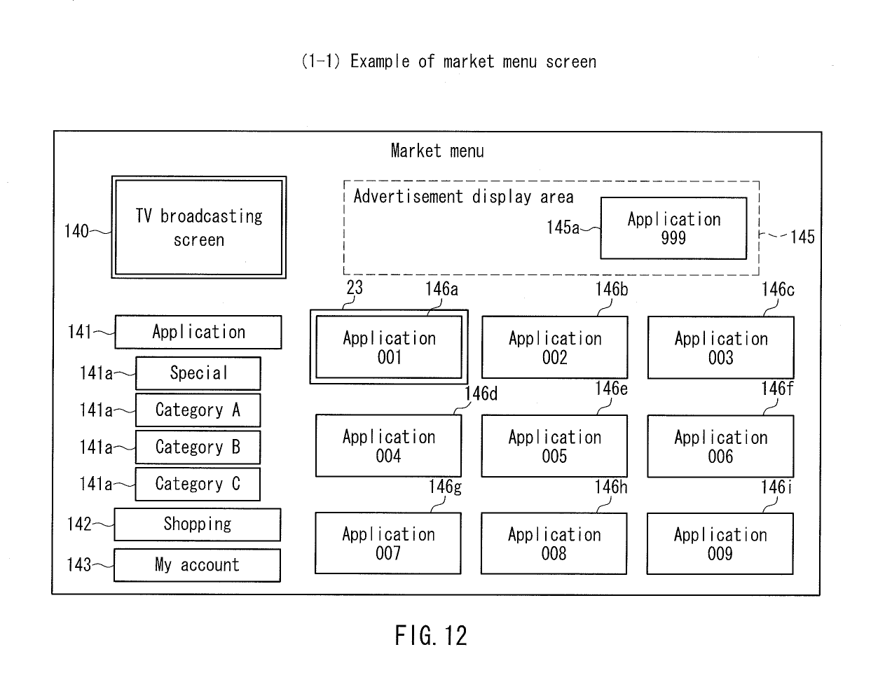

FIG. 12 is a diagram showing an example of the “(1-1) Market menu screen”. The “(1-1) Market menu screen” includes a TV broadcasting screen 140, an advertisement display region 145, an “Application” icon 141, a “Shopping” icon 142, a “My account” icon 143, an “Application 001” icon 146a, an “Application 002” icon 146b, an “Application 003” icon 146c, . . . etc. The advertisement display region 145 includes an “Application 999” icon 145a as advertisement.

Note that, in the foregoing, for example, the “Application 001” is a product name of application software held by the product name 83 of the product data 554 (FIG. 8). The application software includes, for example, a game app, various utility apps, an SNS app, a music replay app, an image reproduction app, a search app, an education app, or the like.

The “(1-1) Market menu screen” includes category-based icons 141a on a lower side of the “Application” icon 141. The category-based icons 141a are displayed, for example, as icons classified depending on kinds: “Special”, “Category A”, “Category B”, and “Category C”. When any one of the category-based icons 141a is selected, the TV device 10a narrows down target application software programs in accordance with the kind of the category-based icon 141a. After the TV device 10a narrows down the target application software programs, the TV device 10a appropriately changes the display and arrangement of the “Application 001” icon 146a, the “Application 002” icon 146b, the “Application 003” icon 146c, . . . etc. so that they correspond to the respective application software programs.

The “Application 001” icon 146a, the “Application 002” icon 146b, the “Application 003” icon 146c, . . . etc. are created based on each record held in the above-mentioned product data 554. For example, the “Application 001” icon 146a, the “Application 002” icon 146b, the “Application 003” icon 146c, . . . etc. are created based on records of product IDs in which the product type 82 is the “Hosted application software” and the “Download application software” in the product data 554.

For example, in the case of purchasing application software corresponding to the “Application 001”, for example, the user operates the direction key 24 of the remote controller 36 (FIG. 11) to set the icon selection frame 23 (FIG. 12) to the “Application 001” icon 146a in the “(1-1) Market menu screen” shown in FIG. 12. When the user presses the enter key 25 (FIG. 11) while the icon selection frame 23 is set to the “Application 001” icon 146a, the CPU 32 of the TV device 10a displays the “(1-2) Application screen”.

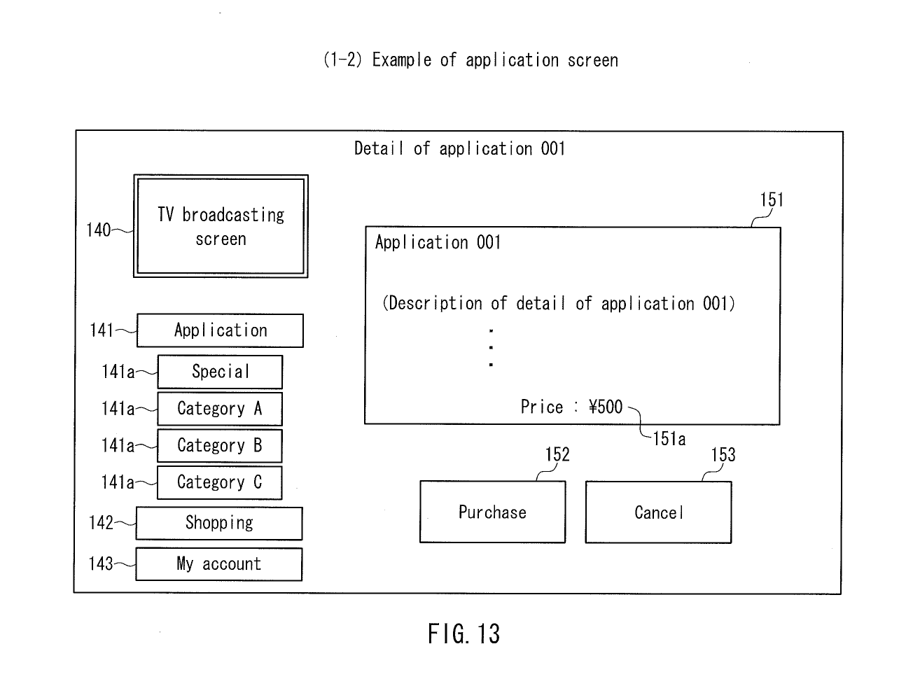

FIG. 13 is a diagram showing an example of the “(1-2) Application screen”. In the same way as in FIG. 12, the “(1-2) Application screen” includes the TV broadcasting screen 140, the “Application” icon 141, the category-based icons 141a, the “Shopping” icon 142, and the “My account” icon 143.

The “(1-2) Application screen” includes a detailed explanation screen 151 associated with the “Application (game A) 001” icon 146a selected in FIG. 12. The detailed explanation screen 151 displays a detailed explanation of the “Application (game A) 001”. The application (game A) 001 is chargeable application software, and hence a price “¥500” 151a is displayed on the detailed explanation screen 151.

The “(1-2) Application screen” shown in FIG. 13 includes a “Purchase” button 152 for requesting installation of the selected application software, and a “Cancel” button 153 for canceling the selection of the application software to return to the “(1-1) Market menu screen”.

When the “Purchase” button 152 is selected, the CPU 32 of the TV device 10a sends selection data containing “001” indicating the product ID of the “Application (game A) 001” associated with the “Purchase” button 152 to the management server device 11.

When the TV device 10a sends the selection data, the CPU 52 of the management server device 11 performs installation processing of the “Application (game A) 001” after predetermined user registration processing (not shown), login processing (not shown), and settlement processing (not shown). Thus, the TV device 10a can execute the selected application software.

For example, in the installation processing of the “Application (game A) 001”, as shown in the record 60 of the startup management table data 552 shown in FIG. 6, a product ID “001” of the “Application (game A) 001” is recorded as the product ID (1) 63 “001” so as to be associated with the terminal ID 61 “d001” and the group ID 62 “g001” corresponding to the TV device 10a. Thus, the TV device 10a can start the “Application (game A) 001” that is the application software purchased by the user through the “(0) Main menu screen”. Accordingly, the management server device 11 can manage that the “Application (game A) 001” that is application software purchased by the user can be started in the TV device 10a.

Further, as shown in the record 70 of the user management table data 553 shown in FIG. 7, the product ID “001” of the “Application (game A) 001” and the terminal ID “d001” of the TV device 10a are recorded as the purchase product ID (1) 73 “001” and the terminal capable of starting application software (1) 74 “d001” so as to be associated with the user ID 71 “h001” and the password 72 “p001”.

On the other hand, in the case where the “Cancel” button 153 is selected in the “(1-2) Application screen” shown in FIG. 13, the CPU 52 of the management server device 11 causes the TV device 10a to display the “(1-1) Market menu screen” shown in FIG. 12 again.

Note that, as described above, the application software includes the “Hosted application software” or the “Download application software”. In the case of installing the “Hosted application software” for purchasing an execution right of application software on a remote server, the CPU 52 of the management server device 11 performs various settings so that the TV device 10a can execute the “Hosted application software” on the management server device 11.

On the other hand, in the case of installing the “Download application software”, the CPU 52 of the management server device 11 causes the TV device 10a to download the “Download application software” and performs processing so that the “Download application software” can be executed on the TV device 10a. For example, the CPU 52 causes the TV device 10a to download application software and allows the downloaded application software to be recorded on the external memory 37b (FIG. 3) of the TV device 10a.

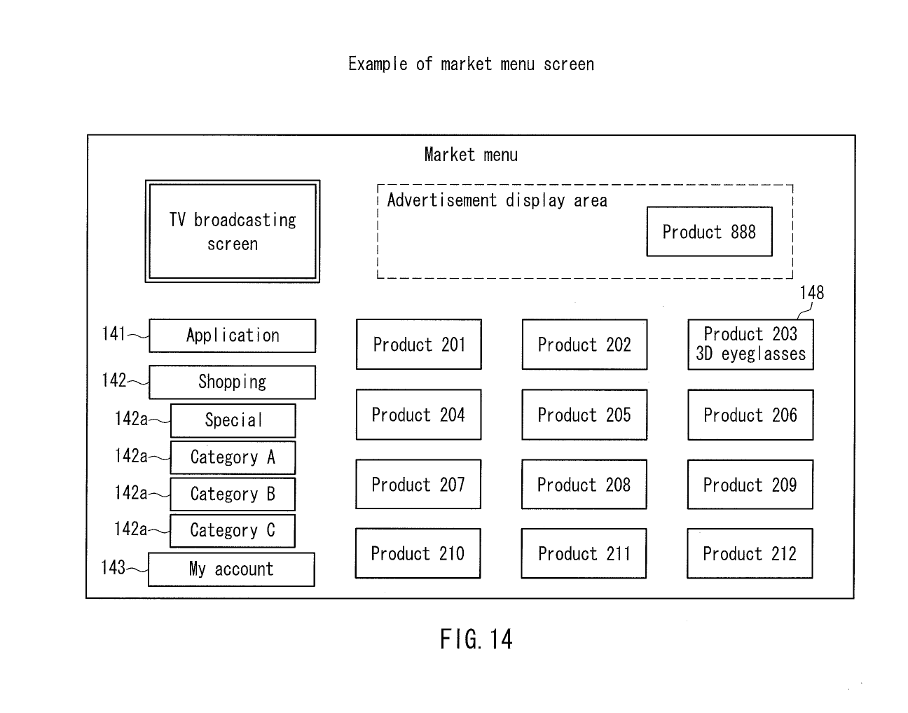

Note that, the user can purchase a product (for example, an article that is a thing) other than application software through use of the market menu shown in FIG. 12. For example, the user can purchase a product other than application software by selecting the “Shopping” icon 142 shown in FIG. 12. FIG. 14 shows the “(1-1) Market menu screen” in the case where the user selects the “Shopping” icon 142. The “(1-1) Market menu screen” shown in FIG. 14 includes category-based icons 142a regarding commodities other than application software in a lower portion of the “Shopping” icon 142.

When the user selects an icon 148 of a “Product 203 3D eyeglasses” in the “(1-1) Market menu screen” shown in FIG. 14, the CPU 52 causes the TV device 10a to display a detailed screen (not shown) of the “Product 203 3D eyeglasses”. When the user presses the “Purchase” button on the detailed screen, the CPU 52 of the management server device 11 executes purchase processing of the “Product 203 3D eyeglasses” that is an article. Thus, the “Product 203 3D eyeglasses” that is an article is delivered to the user.

Note that, as shown in a record 70a of the user management table data 553 shown in FIG. 7, the product ID “203” of the “Product 203 3D eyeglasses” is recorded as part of purchase history so as to be associated with a user ID 71 “h002” and a password 72 “p002” as a purchase product ID (3) 77 “203”. Note that, the “Product 203 3D eyeglasses” is not application software but an article and has no terminal capable of starting application software, and hence “NULL” is set in a data section of the terminal capable of starting application software (3).

[1-4-2. Example of Possessed Application List Screen Display Processing]

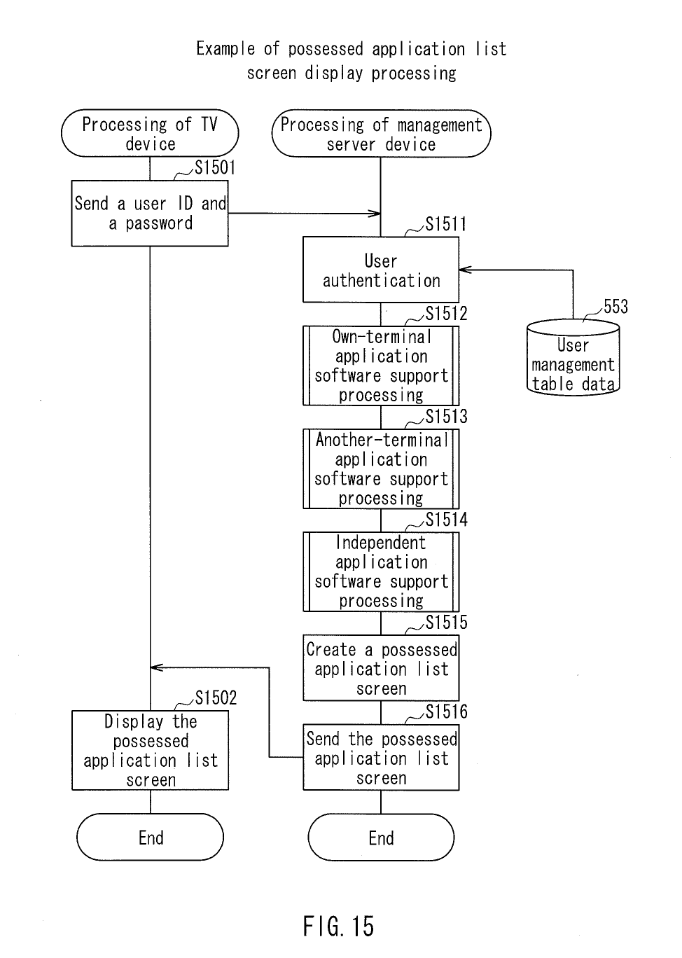

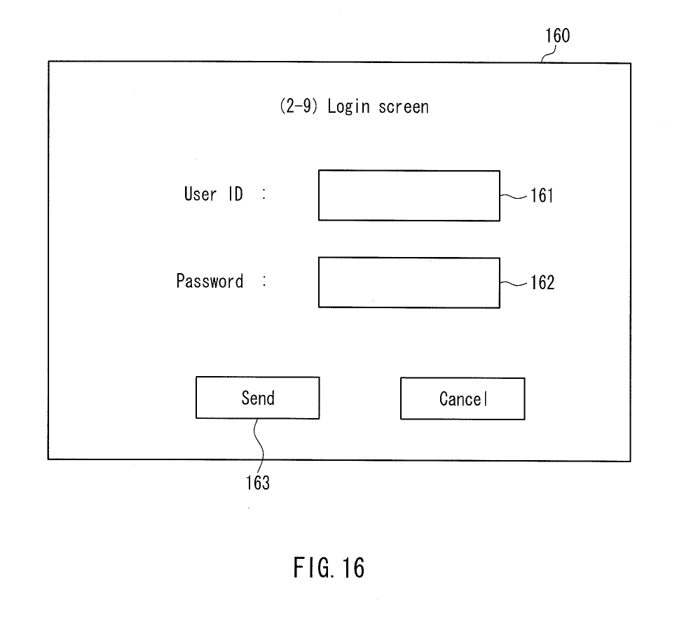

FIG. 15 is a diagram showing an example of a flowchart of possessed application list screen display processing. The possessed application list screen is a screen for displaying a list of application software currently owned by the user of the TV device. FIG. 16 is a diagram showing an example of a “(2-9) Login screen”.

In the “(1-1) Market menu screen” shown in FIG. 12, the user can perform various settings of the TV device 10a by selecting the “My account” icon 143. When the user selects the “My account” icon 143 of FIG. 12, the CPU 52 of the management server device 11 causes the TV device 10a to display, for example, the “(2-9) Login screen” 160 of FIG. 16.

When the user inputs a predetermined user ID and password to a user ID input section 161 and a password input section 162 and presses a submit button 163 through use of the remote controller 36 in the “(2-9) Login screen” 160 shown in FIG. 16, the CPU 32 of the TV device 10a sends the input user ID and password to the management server device 11 (Step S1501 in FIG. 15). Further, in this case, the CPU 32 of the TV device 10a automatically sends the terminal ID and the group ID of the TV device 10a to the management server device 11. Note that, besides the foregoing, the management server device 11 may grasp the terminal ID and the group ID of the TV device 10a based on the received user ID and password.

The CPU 52 of the management server device 11 performs user authentication based on the user ID and the password sent from the TV device 10a (Step S1511). For example, in the case where a combination of the user ID and the password is present in the user management table data 553 (FIG. 7), the CPU 52 determines that the user is valid. Specifically, in the case where the user inputs “h001” as the user ID and inputs “p001” as the password, a combination of the user ID 71 “h001” and the password 72 “p001” is present in the record 70 of the user management table data 553 shown in FIG. 7, and hence the CPU 52 determines that the user is valid.

Note that, in the case where the user authentication of a target user is successful even once, the subsequent “(2-9) Login screen” 160 can be omitted. For example, the CPU 52 of the management server device 11 holds the terminal ID in which the user authentication (Step S1511) has been successful in the memory 53 or the hard disk 55, and in the case where a terminal ID contained in the terminal information data 37a2 (FIG. 4) received from the TV device 10a is held as the terminal ID in which the user authentication has been successful, the display of the “(2-9) Login screen” 160 can be omitted. In this case, when the user selects the “My account” icon 143 of FIG. 12, the CPU 52 of the management server device 11 skips Step S1511 and executes the subsequent Step S1512.

[1-4-2-1. Example of Own-Terminal Application Software Support Processing]

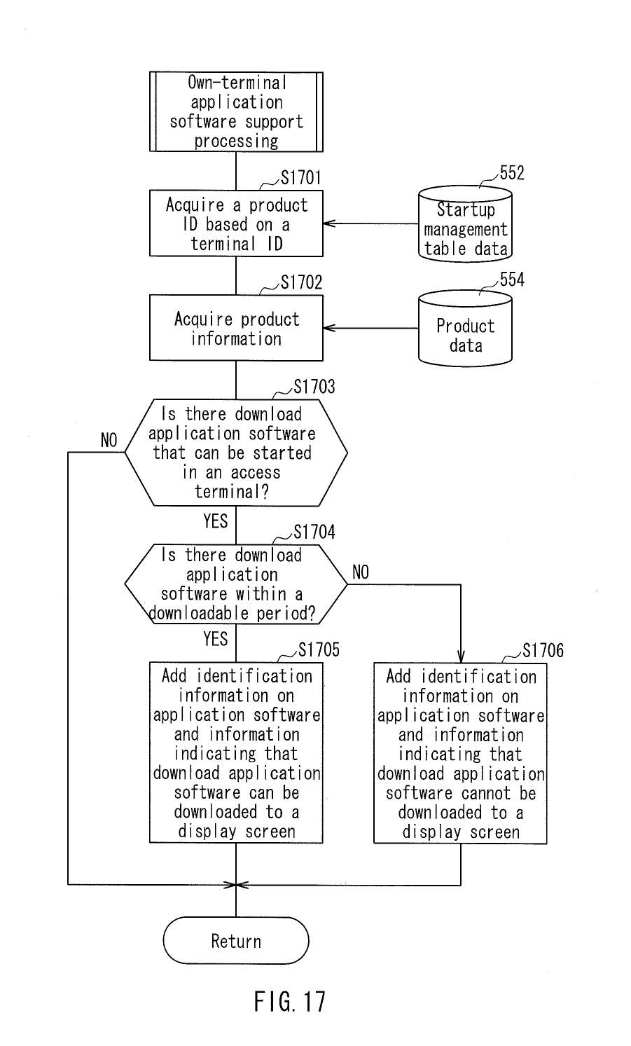

FIG. 17 is a diagram showing an example of a flowchart of own-terminal application software support processing in Step S1512 of FIG. 15. For example, the own-terminal application software support processing can handle the case where it is necessary for the user to reinstall download application software, which the user purchased in the past, in a TV device when the setting of the TV device is reset due to repairs for failures or the like.

The CPU 52 of the management server device 11 acquires all product IDs of application software that can be started in the TV device 10a from the startup management table data 552 (FIG. 6) based on the terminal ID of the TV device 10a (Step S1701). For example, the CPU 52 extracts the record 60 having the same terminal ID 61 “d001” as the terminal ID 41 “d001” of the terminal information data (FIG. 4) of the TV device 10a, and acquires the product ID (1) 63 “001” included in the extracted record 60.

Note that, the CPU 52 also can acquire product IDs of application software that can be started in the TV device 10a by reading each data on a purchase product ID of the user management table data 553 (FIG. 7). Specifically, the CPU 52 also can acquire the purchase product ID (1) 73 “001” associated with the terminal capable of starting application software (1) 74 “d001” from the record 70 of FIG. 7.

The CPU 52 further acquires product information associated with the product ID acquired in Step S1701 with reference to the product data 554 shown in FIG. 8 (Step S1702). For example, the CPU 52 acquires information such as the product ID 81 “001”, the product type 82 “Download application software”, the product name 83 “Game A”, the requested specifications information 84 “01001 . . . ”, the file name 85 “a001.exe”, and the size 86“1.0 MB” corresponding to the product ID “001” acquired in Step S1701 from the record 80 of the product data 554 (FIG. 8).

The CPU 52 determines whether or not there is download application software that can be started in the TV device 10a serving as an access terminal (own-terminal) in the acquired product information (Step S1703). For example, the CPU 52 determines that there is download application software that can be started in the TV device 10a in the product information acquired in Step S1702 when the product of the product ID 81 “001” is the product type 82 “Download application software” (YES in Step S1703).

Further, when the download application software is within a downloadable period (YES in Step S1704), the CPU 52 adds identification information on application software and information indicating that download application software can be downloaded to screen data for forming a possessed application list screen described later (Step S1705).

Note that the CPU 52 can determine whether or not the download application software is within the downloadable period, based on a “Downloadable period” (not shown) held so as to be associated with a purchase product ID (n) in the user management table data shown in FIG. 7. Further, the subsequent processing after Step S1704 is performed repeatedly for each download application software that can be started in the access terminal (own-terminal).

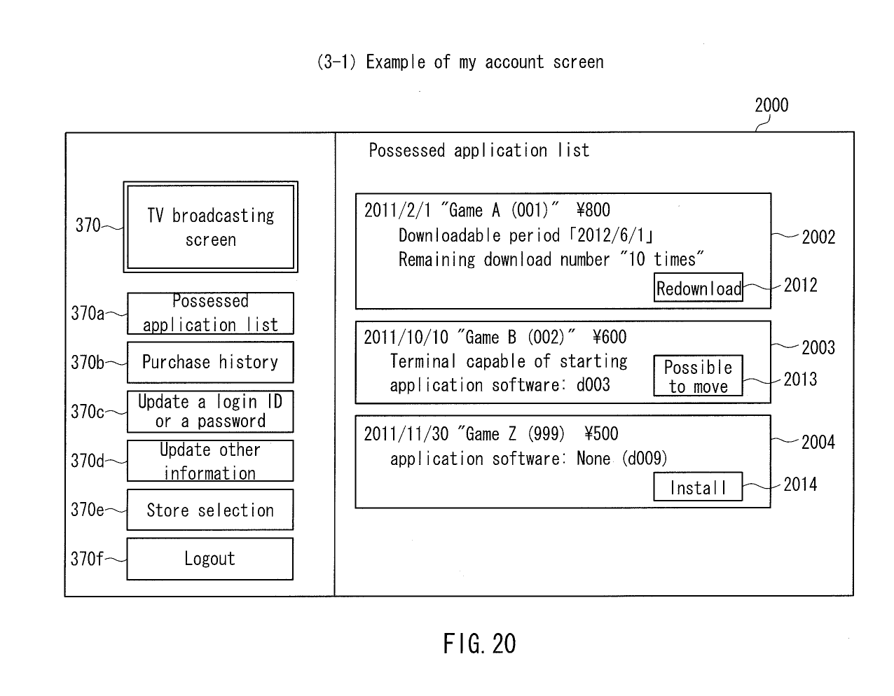

FIG. 20 is a diagram showing an example of a “(3-1) My account screen”. A frame screen 2000 on the right side of FIG. 20 shows a possessed application list screen displayed in the case where a “Possessed application list” icon 370a is selected. Note that the possessed application list screen may be used as a default screen of the “(3-1) My account screen”. Further, as illustrated in FIG. 20, the “(3-1) My account screen” is designed so as to display a “Purchase history” icon 370b, a “Login ID or password update” icon 370c, an “Update of other information” icon 370d, a “Store selection” icon 370e, and a “Logout” icon 370f.

A display area 2002 of FIG. 20 displays, as identification information on download application software, “2011/2/1” indicating a purchase date, “Game A (001)” indicating a product name (product ID), “¥800” indicating a purchase price, “2012/6/1” indicating a downlodable period (YY/MM/DD), and “10 times” indicating the remaining download number. Further, as the information indicating that the download application software can be downloaded, a “Redownload” button 2012 is displayed, which allows download application software to be downloaded again to the TV device 10a.

On the other hand, when the download application software is not within the downloadable period (NO in Step S1704), the CPU 52 adds the identification information on the application software and the information indicating that the download application software cannot be downloaded to the screen data for forming the possessed application list screen (Step S1706). For example, the CPU 52 can cause the above-mentioned “Redownload” button 2012 not to be displayed, as the information indicating that the download application software cannot be downloaded. Further, the CPU 52 can directly display the information indicating that the download application software cannot be downloaded (for example, “Impossible to download”). Further, the CPU 52 can cause all the information shown in the display area 2002 of FIG. 20 not to be displayed.

[1-4-2-2. Example of Another-Terminal Application Software Support Processing]

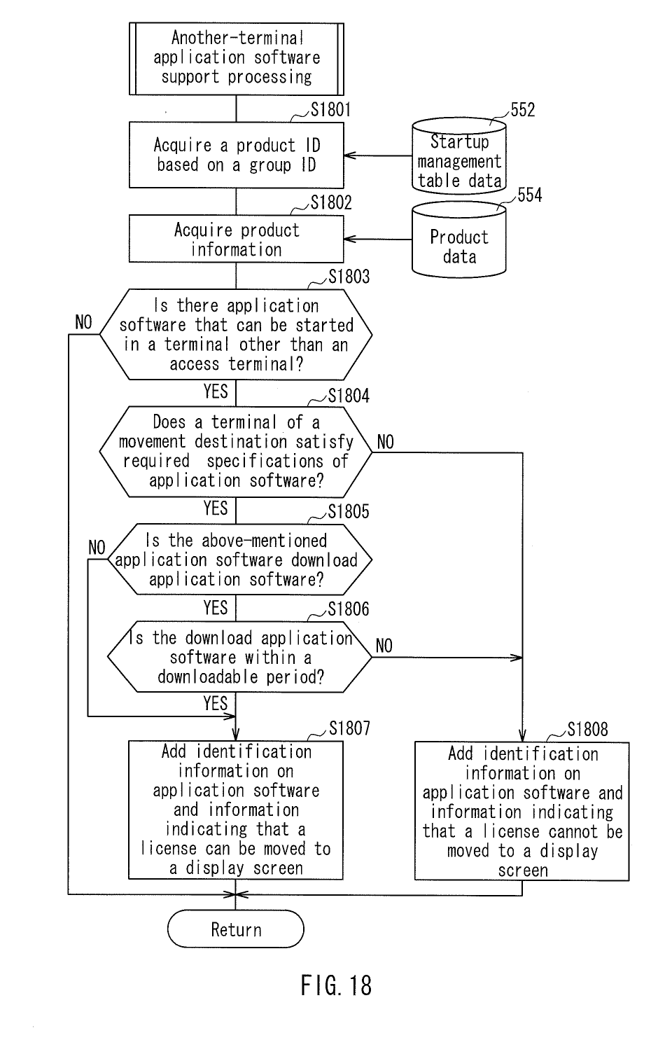

FIG. 18 is a diagram showing an example of a flowchart of another-terminal application software support processing in Step S1513 of FIG. 15. For example, the another-terminal application software support processing can handle the case where it is necessary for the user to reinstall application software, which the user purchased in the past, in a TV device when the setting of the TV device is reset due to repairs or when the user newly purchases the TV device, etc. Further, the another-terminal application software support processing also can handle the case where the user desires to change a TV device which is to start application software.

The CPU 52 of the management server device 11 acquires all product IDs of application software that can be started in each TV device in a group to which the TV device 10a belongs, from the startup management table data 552 (FIG. 6), based on the group ID of the TV device 10a (Step S1801). For example, the CPU 52 extracts records 60 and 60a having the same group ID 62 “g001” as the group ID 42 “g001” of the terminal information data (FIG. 4) of the TV device 10a from the startup management table data 552 (FIG. 6), acquires the product ID (1) 63 “001” contained in the extracted record 60, and acquires a product ID (1) 63 “002” and a product ID (2) 64 “003” contained in the similarly extracted record 60a, respectively.

Note that, the CPU 52 also can acquire a product ID of application software that can be started in each TV device of a group to which the TV device 10a belongs, by reading each data on the purchase product ID of the user management table data 553 (FIG. 7). Specifically, the CPU 52 also can acquire the purchase product ID (1) 73 “001” associated with the terminal capable of starting application software (1) 74 “d001”, the purchase product ID (2) 75 “002” associated with the terminal capable of starting application software (2) 76 “d003”, and the purchase product ID (3) 77 “003” associated with the terminal capable of starting application software (3) 78 “d003”, from the record 70 of FIG. 7.

The CPU 52 acquires product information corresponding to each extracted product ID with reference to the product data 554 shown in FIG. 8 (Step S1802). For example, the CPU 52 acquires information such as a product ID 81 “002”, a product type 82 “Hosted application software”, a product name 83 “Game B”, requested specifications information 84 “01000 . . . ”, and a file name 85 “a002.exe” corresponding to the product ID “002” acquired in Step S1801 from a record 80a of the product data 554 (FIG. 8). Further, for example, the CPU 52 acquires information such as a product ID 81 “003”, the product type 82 “Download application software”, a product name 83 “Game C”, the requested specifications information 84 “00001 . . . ”, a file name 85 “a003.exe”, and a size 86“3.0 MB” corresponding to the product ID “003” acquired in Step S1801 from a record 80b of the product data 554 (FIG. 8).

The CPU 52 determines whether or not there is application software that can be started in a terminal (another terminal) other than the TV device 10a serving as an access terminal (own terminal) in the application software related to the product IDs acquired in Step S1801 (Step S1803). For example, the CPU 52 determines that there is application software that can be started in a terminal (another terminal) other than the TV device 10a because the terminal ID “d003” held so as to be associated with the group ID “g001” in the record 60a of the startup management table data 552 shown in FIG. 6 is a terminal ID other than the terminal ID “d001” of the TV device 10a (own terminal).

Further, the CPU 52 determines whether or not the terminal (own terminal) to be a movement destination satisfies requested specifications of each of the above-mentioned application software (Step S1804). For example, the CPU 52 can determine whether or not the TV device 10a satisfies the requested specifications by comparing the terminal specifications information on the TV device 10a serving as a terminal to be a movement destination with the requested specifications information on the above-mentioned application software. Specifically, the CPU 52 can determine whether or not the TV device 10a satisfies the requested specifications by comparing the terminal specifications information 43 (FIG. 4) sent while being contained in the terminal information data 37a2 in Step S901 of the main menu display processing of FIG. 9 with the requested specifications information 84 of the product data 554 of FIG. 8 by a bit operation or the like. Note that, the subsequent processing after Step S1804 is repeated for each application software that can be started in the terminal (another terminal) other than the access terminal (own terminal).

In the case where the CPU 52 determines that the terminal of a movement destination satisfies the requested specifications of the above-mentioned application software (YES in Step S1804), the CPU 52 determines whether or not the above-mentioned application software is download application software (Step S1805). For example, the CPU 52 determines that the above-mentioned application software is download application software (YES in Step S1805) because the product type 82 of a product of the product ID 81 “003” in the record 80b (FIG. 8) acquired in Step S1802 is “Download application software”.

Further, if the download application software is within the downloadable period (YES in Step S1806), the CPU 52 adds identification information on the application software and information indicating that a license can be moved (for example, “Possible to move”) to the screen data for forming the possessed application list screen (Step S1807). Note that the CPU 52 can determine whether or not the download application software is within the downloadable period, based on a “Downloadable period” (not shown) held so as to be associated with the purchase product ID (n) in the user management table data shown in FIG. 7.

A display area 2003 of FIG. 20 displays, as identification information on application software, “2011/10/10” indicating a purchase date, a “Game B (002)” indicating a product name (product ID), “¥600” indicating a purchase price, and “d003” indicating a terminal currently capable of starting application software. Further, as the information indicating that a license can be moved, a “Possible to move” button 2013 for changing the application software to a state where the application software can be started in the TV device 10a.

On the other hand, if the download application software is not within the downloadable period (NO in Step S1806), the CPU 52 adds identification information on application software and information indicating that a license cannot be moved to screen data for forming the possessed application list screen (Step S1808). For example, the CPU 52 can cause the “Possible to move” button 2013 not to be displayed as the information indicating that a license cannot be moved. Further, the information indicating that a license cannot be moved (for example, “A license cannot be moved because a downloadable period has already expired”) may be displayed directly. Further, the CPU 52 may cause all the information shown in the display area 2003 of FIG. 20 not to be displayed.

In the case where the CPU 52 determines that the above-mentioned application software is not download application software in Step S1805 (No in Step S1805), the CPU 52 adds identification information on the application software and information indicating that a license can be moved (for example, “Possible to move”) to screen data for forming the possessed application list screen (Step S1807). Examples of the screen data to be added in this case are similar to those of the display area 2003 (FIG. 20) in the case of the download application software.

On the other hand, in the case where the CPU 52 determines that the terminal of a movement destination does not satisfy the requested specifications of the application software (NO in Step S1804), the CPU 52 adds identification information on the application software and information indicating that a license cannot be moved to screen data for forming the possessed application list screen (Step S1808). For example, the CPU 52 can cause the “Possible to move” button 2013 not to be displayed as the information indicating that a license cannot be moved. Further, the information indicating that a license cannot be moved (for example, “A license cannot be moved because the terminal does not satisfy the requested specifications) may be displayed directly. Further, the CPU 52 may cause all the information shown in the display area 2003 of FIG. 20 not to be displayed.

[1-4-2-3. Example of Independent Application Software Support Processing]

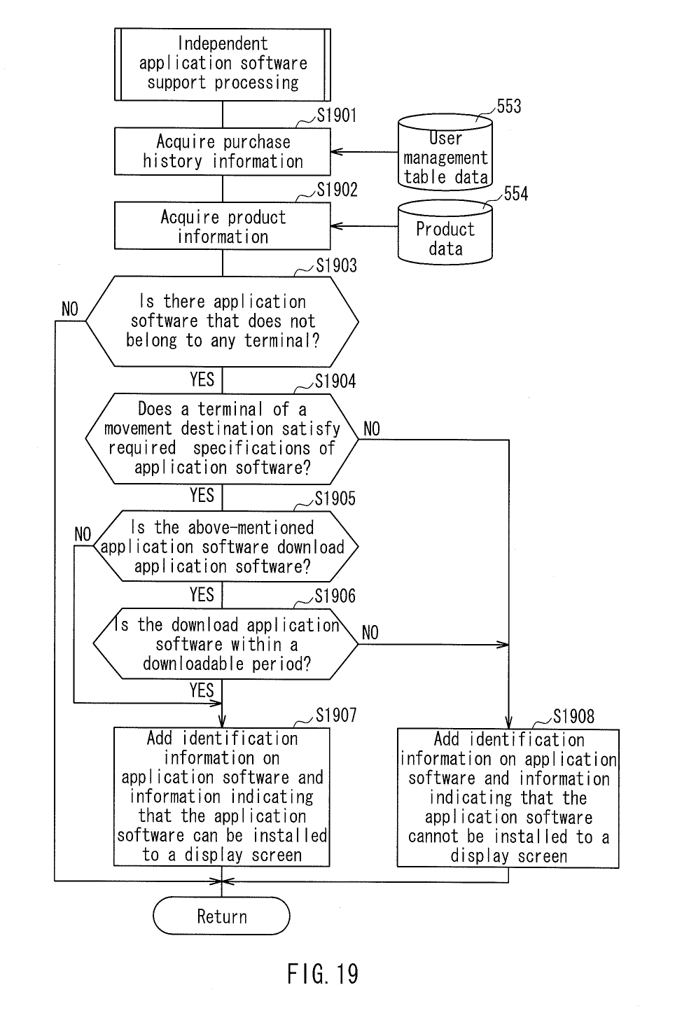

FIG. 19 is a diagram showing an example of a flowchart of independent application software support processing in Step S1514 of FIG. 15. For example, the independent application software support processing can handle the case where the correspondence between the application software which the user purchased in the past and the TV device capable of starting the application software has disappeared when the setting of the TV device is reset due to repairs for failures or replacement purchase. The “independent” in this case refers to the case where the application software does not have correspondence with the TV device capable of starting the application software.

The CPU 52 of the management server device 11 acquires all the respective data on the purchase product ID of the user management table data 553 (FIG. 7) based on the user ID 71 and the password 72 (Step S1901). Subsequently, the CPU 52 acquires product information corresponding to the acquired purchase product ID with reference to the product data 554 shown in FIG. 8 (Step S1902).

The CPU 52 of the management server device 11 determines whether or not there is (independent) application software not belonging to any terminal in purchase history information (Step S1903). For example, the CPU 52 determines that there is application software not belonging to any terminal when the purchase product ID of the user management table data 553 shown in FIG. 7 indicates application software, and the information on terminal capable of starting application software, held so as to be associated with the purchase product ID, is “NULL”. Specifically, the CPU 52 determines whether or not there is application software not belonging to any terminal, when the record of the user management table data of FIG. 7 contains data in which the terminal capable of starting application software ID (n) corresponding to the purchase product ID (n) of application software is “NULL” (not shown) (n is an integer, not shown).

As described above, the management server device 11 can manage independent application software not belonging to any terminal by recording the user ID (by extension, group ID) and the independent application software so that they are associated with each other.

Further, when the CPU 52 determines whether or not there is application software not belonging to any terminal (YES in Step S1903), the CPU 52 determines whether or not a terminal (own-terminal) to be a movement destination can satisfy requested specifications of the application software (Step S1904). For example, the CPU 52 compares the terminal specifications information on the TV device 10a serving as a terminal to be a movement destination with the requested specifications information on the above-mentioned application software, thereby determining whether or not the TV device 10a satisfies the requested specifications. Specifically, the CPU 52 compares the terminal specifications information 43 (FIG. 4) sent as terminal information data in Step S901 of the main menu display processing of FIG. 9 with the requested specifications information 84 of the product data 554 of FIG. 8 by a bit operation or the like, thereby determining whether or not the TV device 10a satisfies the requested specifications.

In the case where the CPU 52 determines that the terminal to be a movement destination satisfies the requested specifications of the application software not belonging to any terminal (YES in Step S1904), the CPU 52 performs processings in Steps S1905 to S1907. Note that each processing in Steps S1905 to S1906 is similar to that in Steps S1805 to S1806 of FIG. 18. Further, in the case where the download application software is within the downloadable period (YES in Step S1906), the CPU 52 adds identification information on the application software and information indicating that the application software can be installed (that is, license movement of the independent application software) (for example, “Install”) to the screen data for forming the above-mentioned possessed application list screen (Step S1907).

In a display area 2004 of FIG. 20, as identification information on the application software, “2011/11/30” indicating a purchase date, “Game Z (999)” indicating a product name (product ID), “¥500” indicating a purchase price, and “None” indicating a current terminal capable of starting application software are displayed. Note that, as shown in the display area 2004 of FIG. 20, information on the past terminal capable of starting application software also may be displayed as “(d009)” with reference to the past data. Further, as the information indicating that the application software can be installed, an “Install” button 2014 for changing the application software so that the application software can be started in the TV device 10a is displayed.

Note that, when the download application software is not within the downloadable period (NO in Step S1906), the CPU 52 adds identification information on the application software and information indicating that the application software cannot be installed to the screen data for forming the above-mentioned possessed application list screen (Step S1908). For example, the CPU 52 can cause the “Install” button 2014 not to be displayed as the information indicating that the application software cannot be installed. Further, the CPU 52 can also directly display the information indicating that the application software cannot be installed (for example, “The application software cannot be installed because the downloadable period has expired”). Further, the CPU 52 also can cause all the information shown in the display area 2004 of FIG. 20 not to be displayed.

On the other hand, in the case where the CPU 52 determines that the terminal to be a movement destination does not satisfy the requested specifications of the application software not belonging to any terminal (NO in Step S1904), the CPU 52 adds the identification information on the application software and the information indicating that the application software cannot be installed to the screen data for forming the above-mentioned possessed application list screen (Step S1908). For example, the CPU 52 can cause the “Install” button 2014 not to be displayed as the information indicating that the application software cannot be installed. Further, the CPU 52 can also directly display the information indicating that the application software cannot be installed (for example, “The application software cannot be installed because the terminal does not satisfy the requested specifications”). Further, the CPU 52 also can cause all the information shown in the display area 2004 of FIG. 20 not to be displayed.

[1-4-2-4. Example of Display Processing of Possessed Application List Screen]

The CPU 52 creates a possessed application list screen displayed on a frame screen 2000 on the right side of FIG. 20 based on the data generated by each processing in Steps S1512 to S1514 of FIG. 15 (Step S1515 of FIG. 15).

The CPU 52 sends the created possessed application list screen to the TV device 10a (Step S1516). For example, the CPU 52 sends “(3-1) My account screen” shown in FIG. 20 to the TV device 10a. In response to the transmission from the management server device 11, the CPU 32 of the TV device 10a causes the display 31 to display, for example, the possessed application list screen shown in FIG. 20 (Step S1502).

In the display area 2000 of FIG. 20, the CPU 52 displays identification information on download application software, another-terminal application software, and independent application software, as information indicating application software owned by the user. However, the CPU 52 also may display application software so that the application software can be switched depending on the type.

For example, the CPU 52 may display the download application software, the another-terminal application software, or the independent application software so that they are switched in response to the pressing of any of the color buttons 26 in the remote controller 36 shown in FIG. 11.

[1-4-3. Example of License Movement Processing]

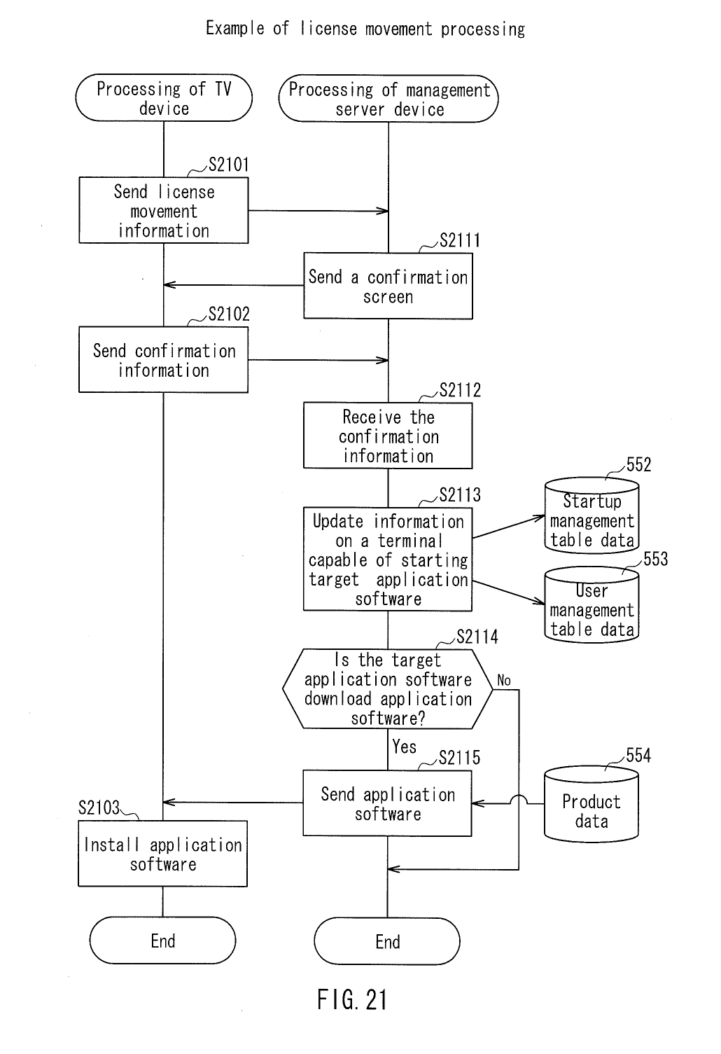

FIG. 21 is a diagram showing an example of a flowchart of license movement processing. The CPU 32 of the TV device 10a serving as a movement destination terminal sends license movement information to the management server device 11 (Step S2101). For example, the CPU 32 sends license movement information in the case where the user presses the “Possible to move” button 2013 shown in the display area 2003 of FIG. 20. The license movement information indicates application software to be changed to a state that can be started in the TV device 10a serving as a movement destination terminal. Specifically, the license movement information contains a user ID “h001”, a password “p001”, a product ID “002”, a terminal capable of starting application software “d001” after the license movement, and the like.

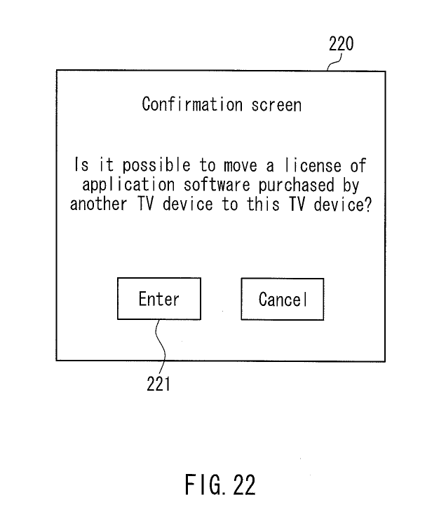

When the CPU 52 of the management server device 11 receives the license movement information from the TV device 10a, the CPU 52 sends, for example, a confirmation screen 220 shown in FIG. 22 to the TV device 10a (Step S2111). The confirmation screen 220 is a screen for urging the user to confirm the movement of a license of application software which is currently capable of being started in another TV device to the TV device 10a. Then the user presses an “Enter” button 221, the CPU 32 of the TV device 10a sends confirmation information to the management server device 11 (Step S2102).

When the CPU 52 of the management server device 11 receives the confirmation information from the TV device 10a (Step S2112), the CPU 52 updates information on a terminal capable of starting target application software (Step S2113). For example, the CPU 52 updates the data on the product ID (2) 64 in the record 60 (FIG. 6) of the startup management table data 552 from “NULL” to “002”. Thus, in the TV device 10a (movement destination terminal) indicated by the terminal ID “d001”, it becomes possible to start the application software of the product ID “002”.

Further, for example, the CPU 52 updates the data on the product ID (1) 63 in the record 60a (FIG. 6) of the startup management table data 552 from “002” to “NULL”. Thus, in the TV device 10b (movement origin terminal) indicated by the terminal ID “d003”, it becomes impossible to start the application software of the product ID “002”. Note that a movement origin terminal may not be updated in the case of application software which is capable of being installed in a plurality of terminals. That is, the application software which is capable of being installed in a plurality of terminals can be set to be available in at least one movement destination terminal or movement origin terminal, in accordance with a user's selection operation. Further, the application software can be set to be independent application software in accordance with the user's selection operation. Note that information indicating the number of terminals in which the application software can be installed may be recorded in the management server device 11 or may be contained in application software itself.

Further, for example, the CPU 52 updates the data on the terminal capable of starting application software (2) 76 corresponding to the purchase product ID (2) 75 in the record 70 (FIG. 7) of the user management table data 553 from “d003” to “d001”. Thus, the management server device 11 can manage the following: the application software (Game B) of the product ID “002” that is the application software that the user purchased can be started in the TV device 10a of the terminal ID “d001”.

Further, in the case where the target application software is download application software, the CPU 52 sends the application software read from the product data 554 to the TV device 10a serving as a movement destination terminal and causes the TV device 10a to install the sent application software (Steps S2114 to S2115, S2103). Thus, even in the case where there is no application software in the TV device 10a serving as a movement destination terminal, the application software can be set to be started in the TV device 10a.

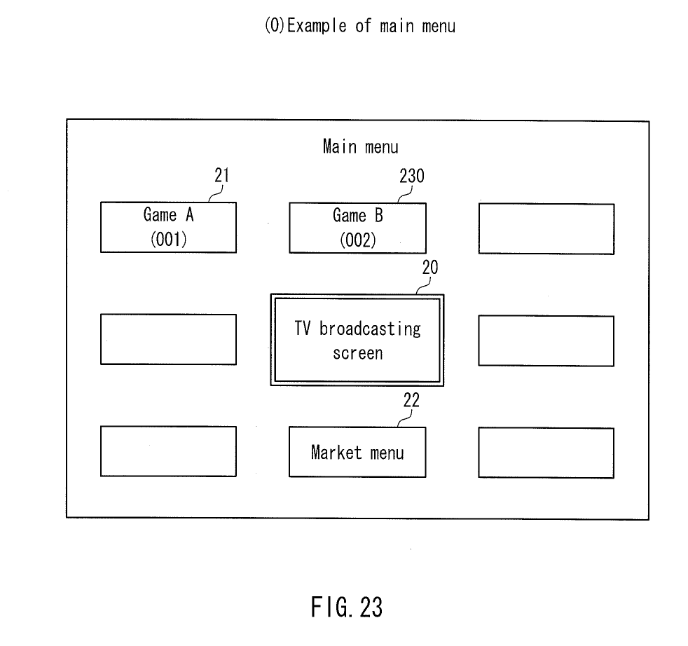

FIG. 23 shows an example of the “(0) Main menu screen” displayed on the display 31 of the TV device 10a after the license movement. A “Game B (002)” icon 230 has been added to the “(0) Main menu screen”. Note that, after the license movement, the “(0) Main menu screen” displayed on the TV device 10b serving as a movement origin terminal can be caused not to display the “Game B (002)” icon 230 (not shown).

[1-5. Summary]

As described above, the terminal management system 1 can easily realize the license movement of application software in a plurality of terminals. In particular, by managing application software that can be started in each terminal (TV device) (referred to as a terminal bind or a device bind) through use of the startup management table data 552, and managing application software available to each user and a terminal (TV device) capable of executing application software (referred to as a user bind) through use of the group ID of the startup management table data 552 or the user management table data 553, a right of executing each application software can be managed flexibly. By flexibly managing an execution right of each application software, a license of application software can be moved easily, and the convenience obtained when the user uses application software among a plurality of terminals can be enhanced.

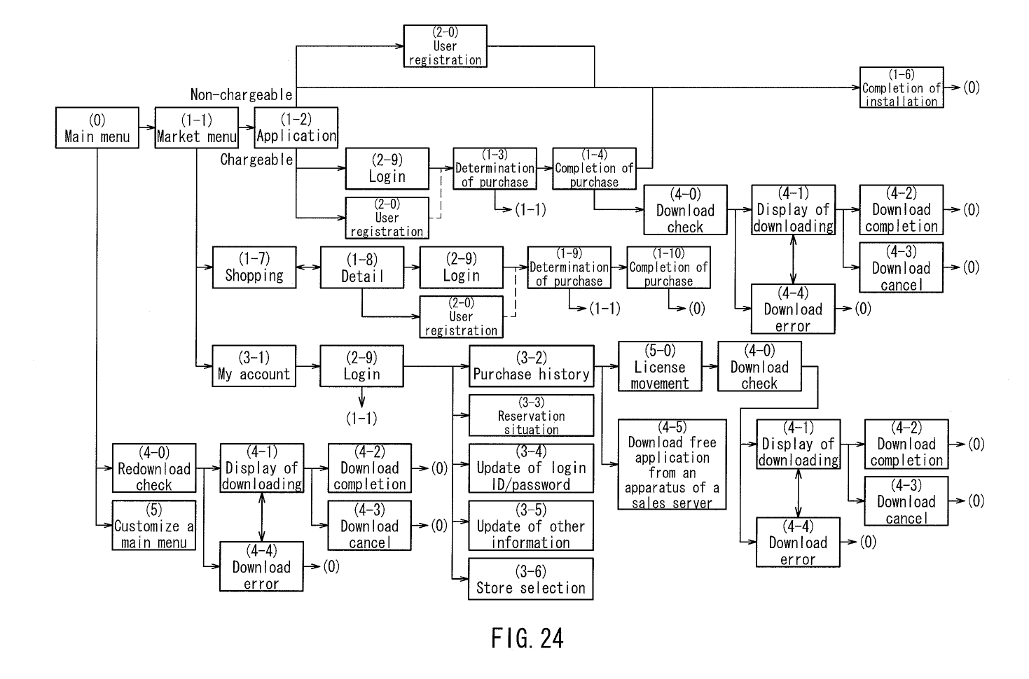

FIG. 24 is a diagram showing an example of screen transition of screen processing based on the display control program 37a1 (FIG. 3) and the display screen control program 551 (FIG. 5). In FIG. 24, the “(0) Main menu screen” is a screen positioned in the uppermost hierarchy in the transition state of the screen. That is, each screen is displayed by transition from the “(0) Main menu screen”.

In this embodiment, the startup target selecting section 112 in the management server includes a processing function in S911 of FIG. 9 as an example. The change target selecting section 113 includes a processing function in S1513 of FIG. 15 or in the flowchart of FIG. 18 as an example. The license movement information receiving section 115 includes a processing function in S2112 of FIG. 21 as an example. The terminal information update section 116 includes a processing function in S2113 of FIG. 21 as an example.

Further, the terminal information sending section 101 in a movement destination terminal includes a processing function in S901 of FIG. 9 as an example. The user information sending section 103 includes a processing function in S1501 of FIG. 15 as an example. The startup target display section 102 includes a processing function in S902 of FIG. 9 as an example. The change target display section 104 includes a processing function in S1502 of FIG. 15 as an example. The license movement information sending section 106 includes a processing function in S2102 of FIG. 21 as an example.

[1-6. Others]

In the above-mentioned embodiment, each functional block shown in the figures is realized by CPU processing that executes software. However, a part or all of the functional blocks may be realized by hardware such as a logic circuit. Note that partial processing of a program may be executed by an OS.

Although the embodiment of the present invention has been described above, the present invention is not limited thereto. Further, regarding the effects described in the embodiment of the present invention, the most preferred effects obtained by the present invention are merely illustrated, and the effects of the present invention are not limited to those described in the embodiment of the present invention.

### INDUSTRIAL APPLICABILITY

The terminal management system according to the present invention can be used in a system including at least one management server device and at least one terminal device. As the terminal device, various devices such as a TV, a recorder, a mobile phone, and a mobile terminal can be used.

### DESCRIPTION OF REFERENCE NUMERALS

1 terminal management system
10a, 10b, 10c TV device
11 management server device

1. A terminal management system comprising: a movement destination terminal to be a movement destination of a license of application software; and a management server capable of communicating with the movement destination terminal,
wherein the management server:
manages a terminal ID of each terminal including the movement destination terminal and a movement origin terminal to be a movement origin of the license, a group ID of a group to which the each terminal belongs, and application software capable of being started in the each terminal so that the terminal ID, the group ID, and the application software are associated with each other; and
includes a change target selecting section for selecting application software capable of being changed to a state that can be started in the movement destination terminal from application software that is currently capable of being started in the movement origin terminal belonging to the same group as that of the movement destination terminal based on the terminal ID and the group ID received from the movement destination terminal, and sending information on the selected application software to the movement destination terminal,
the movement destination terminal includes:
a terminal information sending section for sending the terminal ID and the group ID of the movement destination terminal to the management server; and
a change target display section for displaying the information on the application software selected in the change target selecting section.

2. The terminal management system according to claim 1, wherein the management server manages independent application software that does not belong to any terminal including the movement destination terminal and the movement origin terminal, and
the change target selecting section selects application software capable of being changed to a state that can be started in the movement destination terminal from the independent application software.

3. The terminal management system according to claim 1, wherein the management server includes:
a license movement information receiving section for receiving license movement information containing information on application software to be changed to a state that can be started in the movement destination terminal from the movement destination terminal; and
a terminal information update section for updating information on a terminal capable of starting the application software based on the received license movement information,
the movement destination terminal includes a license movement information sending section for sending the license movement information to the management server.

4. The terminal management system according to claim 1, wherein the terminal information sending section of the movement destination terminal further sends ability information on the movement destination terminal to the management server, and
the change target selecting section of the management server selects application software capable of being changed to a state that can be started in the movement destination terminal based on the ability information.

5. A management server capable of communicating with a movement destination terminal to be a movement destination of a license of application software,
wherein the management server:
manages a terminal ID of each terminal including the movement destination terminal and a movement origin terminal to be a movement origin of the license, a group ID of a group to which the each terminal belongs, and application software capable of being started in the each terminal so that the terminal ID, the group ID, and the application software are associated with each other; and
includes a change target selecting section for selecting application software capable of being changed to a state that can be started in the movement destination terminal from application software that is currently capable of being started in the movement origin terminal belonging to the same group as that of the movement destination terminal based on the terminal ID and the group ID received from the movement destination terminal, and sending information on the selected application software to the movement destination terminal.

6. The management server according to claim 5, wherein the management server manages independent application software that does not belong to any terminal including the movement destination terminal and the movement origin terminal, and
the change target selecting section selects application software capable of being changed to a state that can be started in the movement destination terminal from the independent application software.

7. The management server according to claim 5, comprising:
a license movement information receiving section for receiving license movement information containing information on application software to be changed to a state that can be started in the movement destination terminal from the movement destination terminal; and
a terminal information update section for updating information on a terminal capable of starting the application software based on the received license movement information.

8. The management server according to claim 5, wherein the change target selecting section selects application software capable of being changed to a state that can be started in the movement destination terminal based on ability information from the movement destination terminal.

9. A terminal capable of communicating with a management server for managing a license of application software in a plurality of terminals,
wherein the terminal:
sends a terminal ID assigned to the terminal and a group ID of a group to which the terminal belongs to the management server; and
receives and displays information on application software capable of being changed to a state that can be started in the terminal from application software that is currently capable of being started in a movement origin terminal belonging to the same group as that of the terminal, selected by the management server based on the sent terminal ID and group ID.

10. A program forming a management server capable of communicating with a movement destination terminal to be a movement destination of a license of application software through use of a computer,
wherein the program manages a terminal ID of each terminal including the movement destination terminal and a movement origin terminal to be a movement origin of the license, a group ID of a group to which the each terminal belongs, and application software capable of being started in the each terminal so that the terminal ID, the group ID, and the application software are associated with each other, and
the program causes the computer to execute change target selecting processing for selecting application software capable of being changed to a state that can be started in the movement destination terminal from application software that is currently capable of being started in the movement origin terminal belonging to the same group as that of the movement destination terminal based on the terminal ID and the group ID received from the movement destination terminal, and sending information on the selected application software to the movement destination terminal.

11. The program according to claim 10, comprising:
managing independent application software that does not belong to any terminal including the movement destination terminal and the movement origin terminal, and
selecting application software capable of being changed to a state that can be started in the movement destination terminal from the independent application software in the change target selecting processing.

12. The program according to claim 10, wherein, subsequent to the change target selecting processing, the program causes the computer to execute:
license movement information receiving processing of receiving license movement information containing information on application software to be changed to a state that can be started in the movement destination terminal from the movement destination terminal; and
terminal information update processing of updating information on a terminal capable of starting the application software based on the received license movement information.

13. The program according to claim 10, comprising selecting application software capable of being changed to a state that can be started in the movement destination terminal based on ability information from the movement destination terminal in the change target selecting processing.

14. A method for managing a terminal through use of a movement destination terminal to be a movement destination of a license of application software and a management server capable of communicating with the movement destination terminal,
wherein the management server:
manages a terminal ID of each terminal including the movement destination terminal and a movement origin terminal to be a movement origin of the license, a group ID of a group to which the each terminal belongs, and application software capable of being started in the each terminal so that the terminal ID, the group ID, and the application software are associated with each other; and
executes change target selecting processing for selecting application software capable of being changed to a state that can be started in the movement destination terminal from application software that is currently capable of being started in the movement origin terminal belonging to the same group as that of the movement destination terminal based on the terminal ID and the group ID received from the movement destination terminal, and sending information on the selected application software to the movement destination terminal.

15. The method for managing a terminal according to claim 14, comprising:
managing independent application software that does not belong to any terminal including the movement destination terminal and the movement origin terminal, and
selecting application software capable of being changed to a state that can be started in the movement destination terminal from the independent application software in the change target selecting processing.

16. The method for managing a terminal according to claim 14, wherein, subsequent to the change target selecting processing, the management server executes:
license movement information receiving processing of receiving license movement information containing information on application software to be changed to a state that can be started in the movement destination terminal from the movement destination terminal; and
terminal information update processing of updating information on a terminal capable of starting the application software based on the received license movement information.

17. The method for managing a terminal according to claim 14, comprising selecting application software capable of being changed to a state that can be started in the movement destination terminal based on ability information from the movement destination terminal in the change target selecting processing.
